(19) United States
(12) Patent Application Publication
(10) Pub. No.: US 2021/0130643 A1
(43) Pub. Date: May 6, 2021

(54) Protective Coatings

(71) Applicant: Nano and Advanced Materials Institute Limited, Hong Kong (CN)

(72) Inventors: Siyue LI, Hong Kong (CN); Ching Man CHAN, Hong Kong (CN)

(21) Appl. No.: 16/949,317

(22) Filed: Oct. 26, 2020

Related U.S. Application Data
(60) Provisional application No. 62/927,734, filed on Oct. 30, 2019.

(51) Int. Cl. C09D 133/08; C08F 220/06; C08F 220/14; C08F 220/18; C08F 226/06; C08F 230/08; C08K 3/04; C08K 3/36; B05D 7/00; B60R 21/13

(52) U.S. Cl. CPC C09D 133/08; B60R 2021/138; C08F 220/14; C08F 220/1804; C08F 226/06; C08F 230/085; C08K 3/042; C08K 3/041; C08K 3/36; B05D 7/52; B60R 21/13; B05D 2201/02; B05D 2502/00; B05D 2601/22; C08F 220/06

(57) ABSTRACT

The present disclosure relates to a coating composition useful for airbag coatings and kits and methods for preparation thereof.

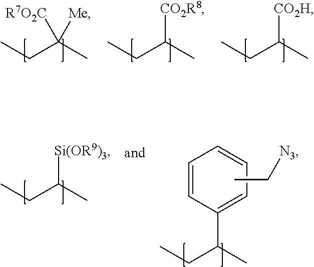

### CROSS REFERENCE TO RELATED APPLICATIONS

This application claims the benefit of priority of U.S. Provisional Application No. 62/927,734 filed on Oct. 30, 2019, which is hereby incorporated by reference in its entirety.

### TECHNICAL FIELD

The present disclosure generally relates to the area of coatings. More particularly, provided herein is a coating composition useful for coating commercial airbag covers, methods of preparing the coating composition, and kits useful for preparing the same.

### BACKGROUND

Owing to growing environmental awareness and increased environmental regulations, there has been a surge in demand for environmentally friendly waterborne coatings, particularly in the automotive industry, which produce lower amounts of volatile organic compound emissions during production and application of the coatings. However, waterborne coatings can have disadvantages, for example, poor mechanical strength, low hardness, water sensitivity, poor film formation and poor adhesion on non-polar substrates, such as polypropylene.

Polypropylene (PP) is a well-known commodity thermoplastic and it is extensively used in a number of automotive applications. It is usually blended with ethylene-propylene-diene-monomer to form polypropylene/ethylene-propylene-diene-monomer (PP-EPDM) to improve its physical properties for industrial usage. PP is a non-polar material with low surface energy, while most waterborne coating compositions are polar and have high surface energy. This large difference in surface energy can cause poor coating wettability on the PP substrate, resulting in film formation problem. This issue is illustrated schematically in FIG. 1A.

There is thus a need to develop improved waterborne compositions that address at least the challenges discussed above.

### SUMMARY

Provided herein is a low cost waterborne dual-layer coating system that is a useful coating composition. The dual-layer system comprises a first layer and a second layer. The primer is applied to enhance the adhesion between the top layer and non-polar substrates, such as PP-EPDM, while the top layer doped with a carbon additive to improve mechanical and abrasion resistance properties of the coating composition.

In a first aspect, provided herein is a coating composition comprising a first layer and a second layer disposed on top of the first layer, wherein the first layer comprises colloidal silica and a first polymer comprising monomer units represented by the structures:

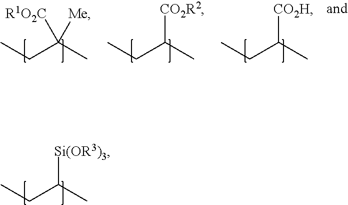

wherein R¹ is alkyl, R² is alkyl, and each R³ is independently hydrogen or an oxygen-silicon covalent bond to at least a portion of the colloidal silica; and

the second layer comprises a carbon additive and a crosslinked polymer comprising a second polymer and a third polymer, wherein the second polymer comprises monomer units represented by the structures:

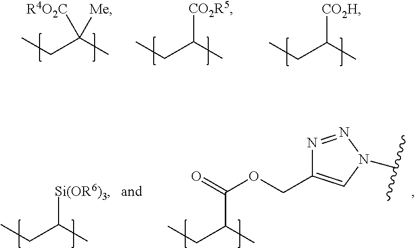

wherein R⁴ is alkyl, R⁵ is alkyl, and each R⁶ is alkyl; and the third polymer comprises monomer units represented by the structures:

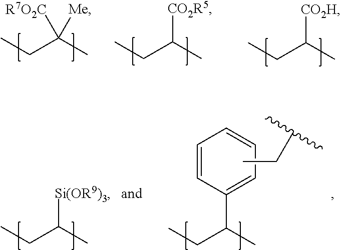

wherein R⁷ is alkyl, R⁸ is alkyl, and each R⁹ is alkyl, wherein

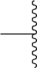

in the second polymer and

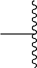

in the third polymer represents a covalent bond therebetween.

In a first embodiment of the first aspect, provided herein is the coating composition of the first aspect, wherein the carbon additive is selected from the group consisting of graphene, graphite, carbon black, carbon nanotubes, and combinations thereof.

In a second embodiment of the first aspect, provided herein is the coating composition of the first aspect, wherein R¹, R⁴, and R⁷ are independently C₁-C₃ alkyl; R², R⁵, and R⁸ are independently C₂-C₆ alkyl; and R⁶ and R⁹ is C₁-C₂ alkyl.

In a third embodiment of the first aspect, provided herein is the coating composition of the first aspect, wherein the first polymer comprises the monomer units:

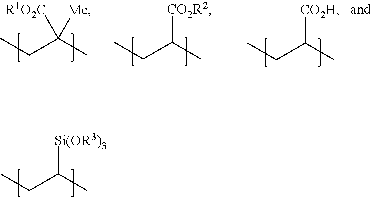

in approximately a 10:10:10:1 molar ratio, respectively.

In a fourth embodiment of the first aspect, provided herein is the coating composition of the third embodiment of the first aspect, wherein the second polymer comprises the monomer units:

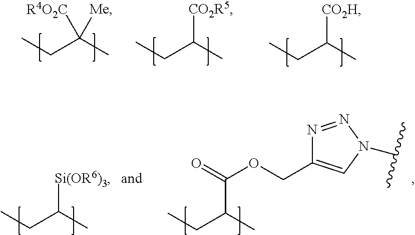

in approximately a 10:10:10:1:1 molar ratio, respectively; and the third polymer comprises the monomer units:

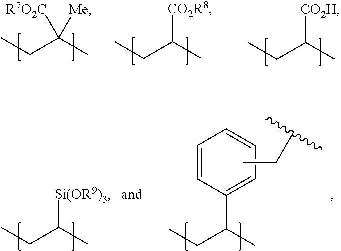

in approximately a 10:10:10:1:1 molar ratio, respectively.

In a fifth embodiment of the first aspect, provided herein is the coating composition of the fourth embodiment of the first aspect, wherein the carbon additive is graphene.

In a sixth embodiment of the first aspect, provided herein is the coating composition of the first aspect, wherein first layer comprises colloidal silica and third polymer in a 4:1 ratio by weight; the first polymer comprises the monomer units:

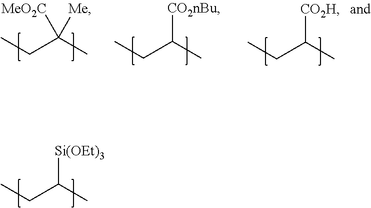

in a 10:10:10:1 molar ratio, respectively; the second polymer comprises the monomer units:

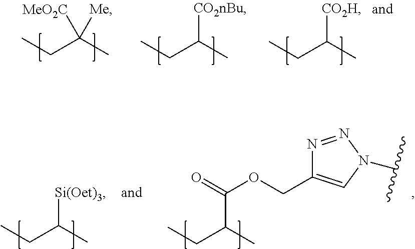

in a 10:10:10:1:1 molar ratio, respectively; the third polymer comprises the monomer units:

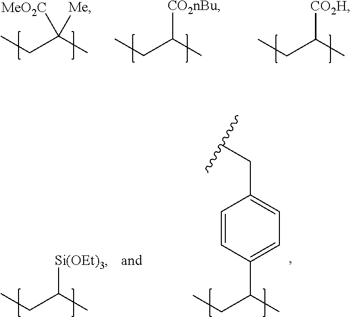

in a 10:10:10:1:1 molar ratio, respectively; and the carbon additive is graphene.

In a second aspect, provided herein is a method for applying the coating composition of the first aspect to a substrate, the method comprising: contacting the surface of the substrate with a first composition comprising colloidal silica and a first polymer comprising monomer units represented by the structures:

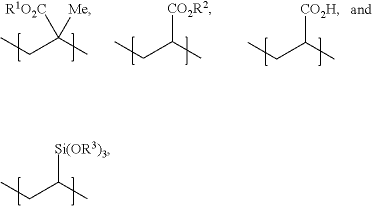

wherein R¹ is alkyl, R² is alkyl, and each R³ is independently hydrogen or an oxygen-silicon covalent bond to at least a portion of the colloidal silica thereby forming a first layer disposed on top of the substrate; contacting the surface of the first layer with a second composition comprising a carbon additive, a second polymer precursor, and a third polymer precursor, wherein the second polymer precursor comprises monomer units represented by the structures:

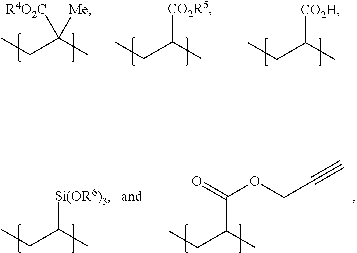

wherein R⁴ is alkyl, R⁵ is alkyl, and each R⁶ is alkyl; and the third polymer precursor comprises monomer units represented by the structures:

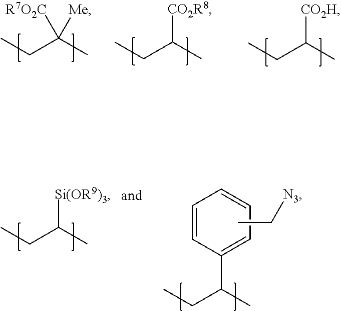

wherein R⁷ is alkyl, R⁸ is alkyl, and each R⁹ is alkyl thereby forming a thin film disposed on top of the first layer; and subjecting the thin film to a condition for facilitating a [3+2]cycloaddition reaction of the second polymer precursor and the third polymer precursor thereby forming the second layer comprising the crosslinked polymer.

In a first embodiment of the second aspect, provided herein is the method of the second aspect, wherein the carbon additive is selected from the group consisting of graphene, graphite, carbon black, carbon nanotubes, and combinations thereof.

In a second embodiment of the second aspect, provided herein is the method of the second aspect, wherein the substrate is an airbag cover.

In a third embodiment of the second aspect, provided herein is the method of the second embodiment of the second aspect, wherein the airbag cover comprises polypropylene/ethylene-propylene-diene-monomer (PP-EPDM).

In a fourth embodiment of the second aspect, provided herein is the method of the second aspect, wherein R¹, R⁴, and R⁷ are independently C₁-C₃ alkyl; R², R⁵, and R⁸ are independently C₂-C₆ alkyl; and R⁶ and R⁹ is C₁-C₂ alkyl.

In a fifth embodiment of the second aspect, provided herein is the method of the second aspect further comprising the step of contacting the second composition with a copper salt.

In a sixth embodiment of the second aspect, provided herein is the method of the second aspect, wherein the condition for facilitating the [3+2] cycloaddition reaction comprises subjecting the thin film to heat.

In a seventh embodiment of the second aspect, provided herein is the method of the second aspect further comprising the step of polymerizing:

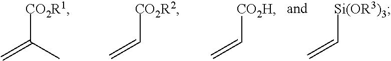

thereby forming a first polymer precursor comprising monomer units represented by the structures:

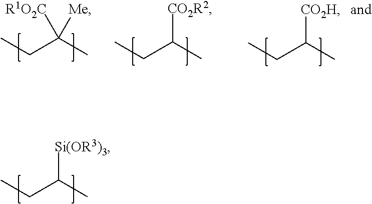

wherein R¹ is alkyl, R² is alkyl, and R³ is alkyl; contacting the first polymer precursor with colloidal silica thereby forming the first polymer.

In a eighth embodiment of the second aspect, provided herein is the method of the seventh embodiment of the second aspect, wherein

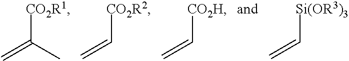

are present in a molar ratio of approximately a 10:10:10:1 to molar ratio, respectively.

In a ninth embodiment of the second aspect, provided herein is the method of the second aspect further comprising the step of polymerizing:

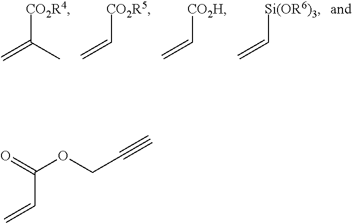

thereby forming the second polymer precursor.

In a tenth embodiment of the second aspect, provided herein is the method of the second aspect further comprising the step of polymerizing:

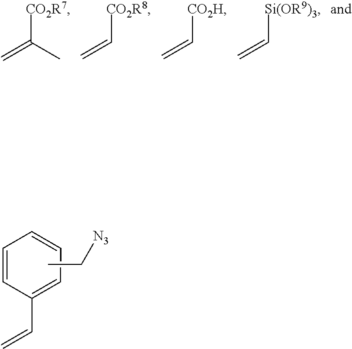

thereby forming the third polymer precursor.

In a third aspect, provided herein is a kit for preparing the coating composition of the first aspect, the kit comprising:

a first container comprising colloidal silica and a first polymer comprising monomer units represented by the structures:

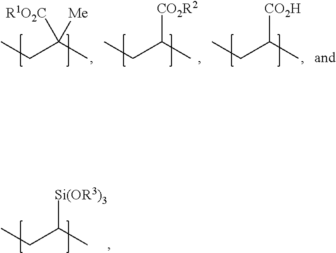

wherein R¹ is alkyl, R² is alkyl, and each R³ is independently hydrogen or an oxygen-silicon covalent bond to at least a portion of the colloidal silica; a second contacting comprising a second polymer precursor comprising monomer units represented by the structures:

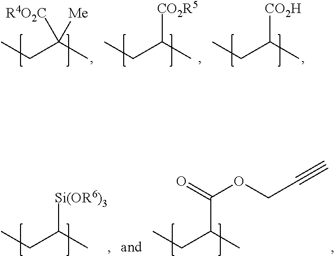

wherein R⁴ is alkyl, R⁵ is alkyl, and each R⁶ is alkyl; and a third container comprising a third polymer precursor comprising monomer units represented by the structures:

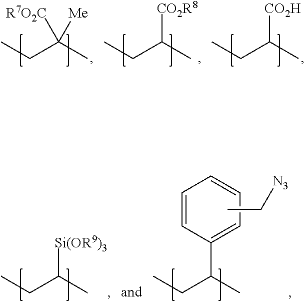

wherein R⁷ is alkyl, R⁸ is alkyl, and each R⁹ is alkyl, wherein at least one of the second container or the third container further comprises a carbon additive.

In a first embodiment of the third aspect, provided herein is the kit of the third aspect further comprising a fourth container comprising a copper salt.

### BRIEF DESCRIPTION OF DRAWINGS

FIG. 1A depicts a schematic illustration depicting the poor wettability caused by large surface energy differences between PP-based substrates and conventional waterborne coatings.

FIG. 1B depicts the coating composition according to certain embodiments described herein.

FIG. 2 depicts Table 1 showing reagents and their exemplary amounts used for preparing the first layer of the coating composition according to certain embodiments described herein.

FIG. 3 depicts an exemplary method for preparing the first polymer precursor according to certain embodiments described herein.

FIG. 4 depicts Table 2 showing exemplary reagents and their amounts used for preparing colloidal silica useful in the preparation of the first layer according to certain embodiments described herein.

FIG. 5 depicts a theoretical mechanism for the hydrolytic condensation of tetraethyl orthosilicate.

FIG. 6 depicts the reaction of the reaction of the first polymer according to certain embodiments described herein and colloidal silica.

FIG. 7A depicts particle size distribution of the first polymer according to certain embodiments described herein.

FIG. 7B depicts particle size distribution of the colloidal silica gel used in the preparation of the first layer according to certain embodiments described herein.

FIG. 8 depicts Fourier-transform infrared (FTIR) spectroscopy of colloidal silica (colloidal silica) according to certain embodiments described herein, the first polymer (PAE) according to certain embodiments described herein; and a composition comprising the first polymer and colloidal silica according to certain embodiments described herein.

FIG. 9 depicts a PP-EPDM airbag cover coated with the first layer according to certain embodiments described herein.

FIG. 10 depicts Table 3 showing testing results of the first layer in accordance with certain embodiments described herein.

FIG. 11A depicts VOC test results of the first layer coating, which was able to comply with the test standard VW 50180.

FIG. 11B depicts testing data of formaldehyde collected from the first layer in accordance with certain embodiments described herein on a substrate and an untreated substrate comparative example.

FIG. 12 depicts data collected for tests for odour.

FIG. 13 depicts a schematic diagram of an exemplary [3+2] cycloaddition (also known as click) reaction between the second polymer precursor and the third polymer precursor in accordance with certain embodiments described herein.

FIG. 14 depicts the synthesis of the first polymer precursor and the second polymer precursor according to certain embodiments described herein.

FIG. 15 depicts Table 4 showing reagents and their amounts used for the preparation of the second polymer precursor according to certain embodiments described herein.

FIG. 16 depicts Table 5 showing reagents and their amounts used for the preparation of 4-vinylbenzyl azide.

FIG. 17 depicts Table 6 showing reagents and their amounts used for the preparation of the third polymer precursor according to certain embodiments described herein.

FIG. 18 depicts the preparation of the crosslinked polymer by [3+2] cycloaddition of the second polymer precursor and the third polymer precursor; application of the first layer and second layer to the substrate.

FIG. 19 depicts FTIR spectra of the first polymer with second polymer and third polymer according to certain embodiments described herein.

FIG. 20 depicts a photograph showing color differences between three vessels containing the first polymer (top); second polymer precursor (middle) and third polymer precursor (bottom) according to certain embodiments described herein.

FIG. 21 depicts Table 7 showing testing data for the second layer according to certain embodiments described herein.

FIG. 22A depicts table showing test reports for TVOC for an untreated airbag cover and an air bag cover treated with a coating composition according to certain embodiments as described herein.

FIG. 22B depicts table showing test reports for formaldehyde for an untreated airbag cover and an air bag cover treated with a coating composition according to certain embodiments as described herein.

FIG. 22C depicts table showing test reports for odour for an untreated airbag cover and an air bag cover treated with a coating composition according to certain embodiments as described herein.

FIG. 22D depicts table showing test reports for fogging for an untreated airbag cover and an air bag cover treated with a coating composition according to certain embodiments as described herein.

FIG. 22E depicts table showing test reports for scratch resistance for an air bag cover treated with a coating composition according to certain embodiments as described herein.

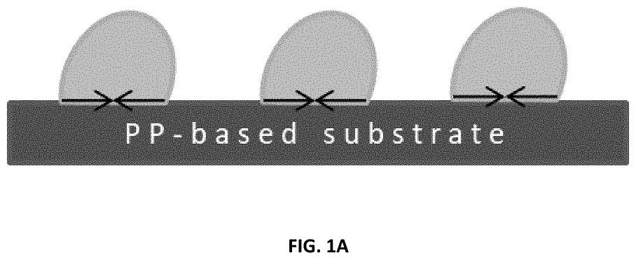

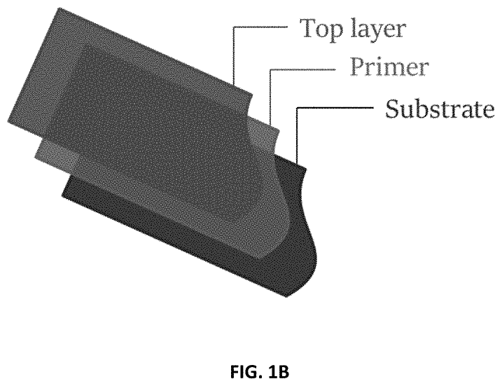

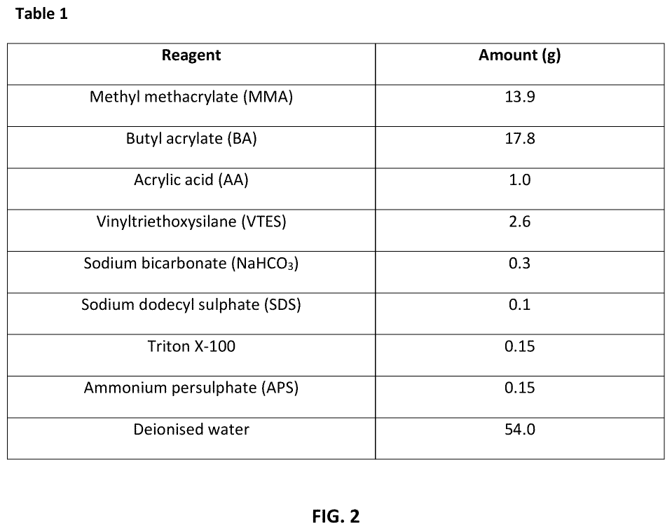

### DETAILED DESCRIPTION

Provided herein are coating compositions comprising a first layer and a second layer as described herein. The first layer may also be referred to as the primer layer and the second layer may also be referred to as the top layer. These terms can be used interchangeably. The first layer has been modified to improve the coating efficiency and durability of the second layer and can have further advantages as described herein. The coating compositions described herein can advantageously be prepared using waterborne coating solution in a simple two-step procedure.

### Definitions

The definitions of terms used herein are meant to incorporate the present state-of-the-art definitions recognized for each term in the field of biotechnology. Where appropriate, exemplification is provided. The definitions apply to the terms as they are used throughout this specification, unless otherwise limited in specific instances, either individually or as part of a larger group.

When trade names are used herein, applicants intend to independently include the trade name product formulation, the generic drug, and the active pharmaceutical ingredient(s) of the trade name product.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein, a “polymeric compound” (or “polymer”) refers to a molecule including a plurality of one or more repeating units connected by covalent chemical bonds. A polymeric compound can be represented by General Formula I:

*-(−(Ma)ₓ-(Mb)_{y}-)_{z}* General Formula I

wherein each Ma and Mb is a repeating unit or monomer. The polymeric compound can have only one type of repeating unit as well as two or more types of different repeating units. When a polymeric compound has only one type of repeating unit, it can be referred to as a homopolymer. When a polymeric compound has two or more types of different repeating units, the term “copolymer” or “copolymeric compound” can be used instead. For example, a copolymeric compound can include repeating units where Ma and Mb represent two different repeating units. Unless specified otherwise, the assembly of the repeating units in the copolymer can be head-to-tail, head-to-head, or tail-to-tail. In addition, unless specified otherwise, the copolymer can be a random copolymer, an alternating copolymer, or a block copolymer. For example, General Formula I can be used to represent a copolymer of Ma and Mb having x mole fraction of Ma and y mole fraction of Mb in the copolymer, where the manner in which comonomers Ma and Mb is repeated can be alternating, random, regiorandom, regioregular, or in blocks, with up to z comonomers present. In addition to its composition, a polymeric compound can be further characterized by its degree of polymerization (n) and molar mass (e.g., number average molecular weight (M) and/or weight average molecular weight (Mw) depending on the measuring technique(s)). The polymers described herein can exist in numerous stereochemical configurations, such as isotactic, syndiotactic, atactic, or a combination thereof.

As used herein, “alkyl” refers to a straight-chain or branched saturated hydrocarbon group. Examples of alkyl groups include methyl (Me), ethyl (Et), propyl (e.g., n-propyl and z′-propyl), butyl (e.g., n-butyl, z′-butyl, sec-butyl, tert-butyl), pentyl groups (e.g., n-pentyl, z′-pentyl, -pentyl), hexyl groups, and the like. In various embodiments, an alkyl group can have 1 to 40 carbon atoms (i.e., C₁-40 alkyl group), for example, 1-30 carbon atoms (i.e., C₁-30 alkyl group). In some embodiments, an alkyl group can have 1 to 6 carbon atoms, and can be referred to as a “lower alkyl group.” Examples of lower alkyl groups include methyl, ethyl, propyl (e.g., n-propyl and z′-propyl), and butyl groups (e.g., n-butyl, z′-butyl, sec-butyl, tert-butyl). In some embodiments, alkyl groups can be substituted as described herein. An alkyl group is generally not substituted with another alkyl group, an alkenyl group, or an alkynyl group.

As used herein, the term “approximately” when used in connection with a molar ratio means up to ±20% of the specified quantities in the molar ratio can vary by +20% or −20%. For example, approximately 1:1 encompasses ratios between 0.8-1.2:0.8-1.2. In certain embodiments, the term approximately when used in connection with a molar ratio means up to ±15%, ±10%, ±9%, ±8%, ±7%, ±6%, ±5%, ±4%, ±3%, ±2%, ±1%, or ±0% of the molar ratio.

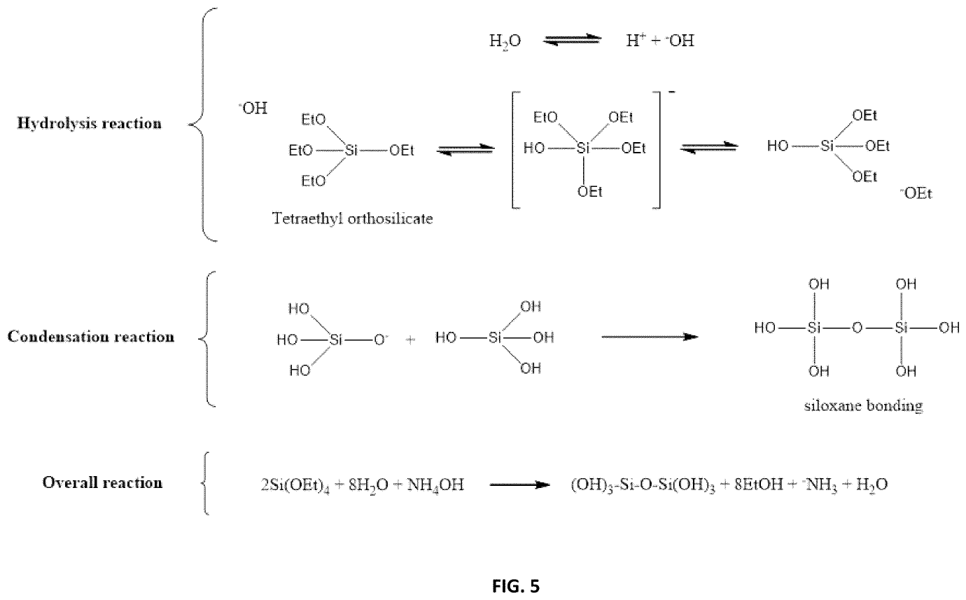

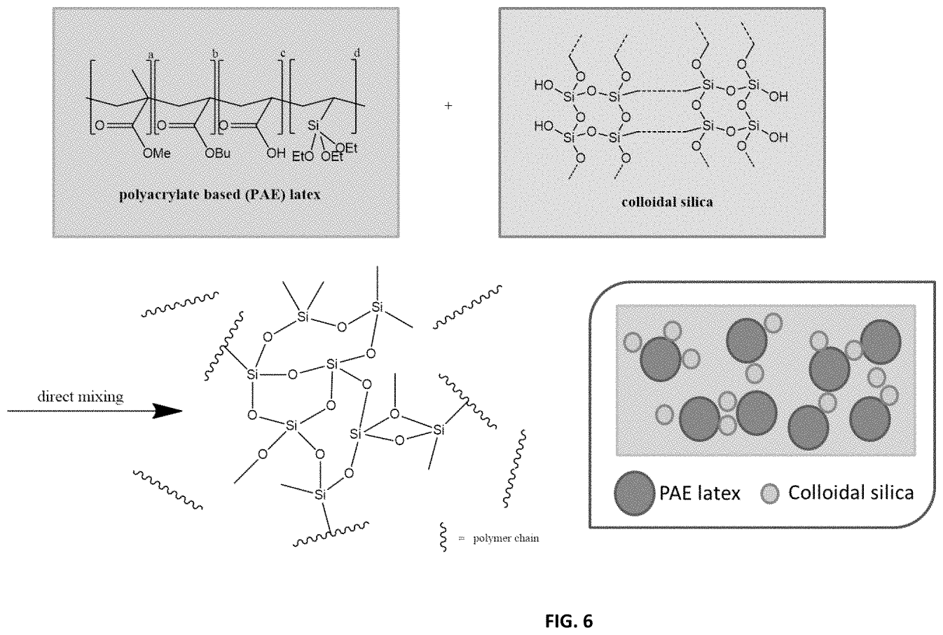

The first layer can comprise a first polymer and colloidal silica gel, wherein at least a portion of the first polymer is covalently bonded to the colloidal silica gel. This process is illustrated schematically in FIG. 6 in which the first polymer (referred to as the polyacrylate based (PAE) latex in FIG. 6) reacts with colloidal silica gel, which results in the formation of a crosslinked network covalently bonding at least some of the colloidal silica with the first polymer. A putative mechanism for this process is shown in FIG. 5.

The first polymer can comprise monomer units represented by the structures:

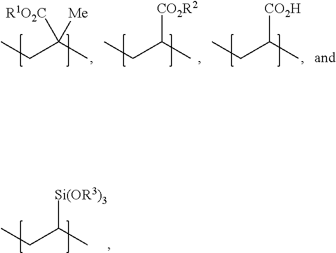

wherein R¹ is alkyl, R² is alkyl, and each R³ is independently hydrogen or an oxygen-silicon covalent bond to at least a portion of the colloidal silica. The first polymer can be a block, alternating, random, regiorandom, or regioregular polymer. The first polymer can be an isotactic polymer, syndiotactic polymer, atactic polymer, or a combination thereof.

In certain embodiments, R¹ is C₁-C₁₀ alkyl, C₁-C₆ alkyl, C₁-C₄ alkyl, C₁-C₃ alkyl, or C₁-C₂ alkyl. In certain embodiments, R¹ is methyl, ethyl, n-propyl, isopropyl, or n-butyl, iso-butyl, or tert-butyl.

In certain embodiments, R² is C₁-C₁₀ alkyl, C₁-C₈ alkyl, C₂-C₈ alkyl, C₂-C₆ alkyl, or C₃-C₅ alkyl. In certain embodiments, R² is methyl, ethyl, n-propyl, iso-propyl, or n-butyl, sec-butyl, iso-butyl, tert-butyl, n-pentyl, or n-hexyl.

In certain embodiments, R¹ is C₁-C₃ alkyl or C₁-C₂ alkyl; and R² is C₂-C₆ alkyl, or C₃-C₅ alkyl. In certain embodiments, R¹ is methyl and R² is n-butyl.

In certain embodiments, each R³ is independently hydrogen or an oxygen-silicon covalent bond to at least a portion of the colloidal silica. When R³ is an oxygen-silicon covalent bond to at least a portion of the colloidal silica, it can be represented by the following structure:

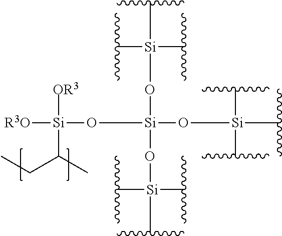

Each particle of colloidal silica may comprise covalent bonds with one or more monomer units of

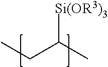

within the same molecule of first polymer, different molecules or first polymer, and combinations thereof.

The structure of each of the monomer units having the structure:

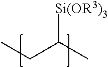

within the first polymer can be independent, and can therefore vary within the first polymer. For example, one first polymer may comprise monomer units, wherein four R³ are an oxygen-silicon covalent bond to at least a portion of the colloidal silica one R³ is hydrogen and three R³ are an oxygen-silicon covalent bond to at least a portion of the colloidal silica; two R³ are hydrogen and two R³ are an oxygen-silicon covalent bond to at least a portion of the colloidal silica; three R³ are hydrogen and one R³ is an oxygen-silicon covalent bond to at least a portion of the colloidal silica; four R³ are hydrogen; and combinations thereof.

The first polymer may comprises the monomer units:

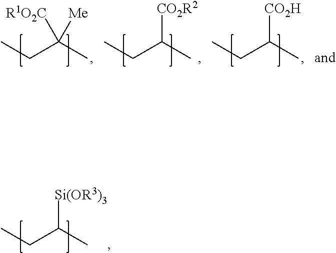

in approximately a 10:10:10:1 molar ratio, respectively; 8-12:8-12:8-12:0.8-1.2 molar ratio, respectively; 9-11:9-11:9-11:0.9-1.1 molar ratio, respectively; 9.5-10.5:9.5-10.5:9.5-10.5:0.95-1.05 molar ratio, respectively; 9.75-10.25:9.75-10.25:9.75-10.25:0.975-1.025 molar ratio, respectively; or 10:10:10:1 molar ratio, respectively.

The first layer may comprise the first polymer and the colloidal silica in any mass ratio. In certain embodiments, first layer comprises the first polymer and the colloidal silica in a 50:1 to 1:1 mass ratio, respectively; 40:1 to 1:1 mass ratio, respectively; 30:1 to 1:1 mass ratio, respectively; 20:1 to 1:1 mass ratio, respectively; 10:1 to 1:1 mass ratio, respectively; 5:1 to 1:1 mass ratio, respectively; 5:1 to 2:1 mass ratio, respectively; 5:1 to 3:1 mass ratio, respectively; or approximately a 4:1 mass ratio, respectively.

The second layer comprises layer comprises a carbon additive and a crosslinked polymer comprising a second polymer and a third polymer.

The carbon additive may be selected from the group consisting of graphene, graphite, carbon black, carbon nanotubes, and combinations thereof. In certain embodiments, the carbon additive is graphene.

The second polymer can comprises monomer units represented by the structures:

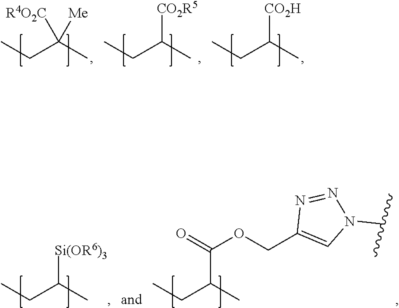

wherein R⁴ is alkyl, R⁵ is alkyl, and each R⁶ is alkyl, wherein

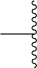

in the second polymer and

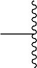

in the third polymer represents a covalent bond therebetween. The second polymer can be a block, alternating, random, regiorandom, or regioregular polymer. The second polymer can be an isotactic polymer, syndiotactic polymer, atactic polymer, or a combination thereof.

In certain embodiments, R⁴ is C₁-C₁₀ alkyl, C₁-C₆ alkyl, C₁-C₄ alkyl, C₁-C₃ alkyl, or C₁-C₂ alkyl. In certain embodiments, R⁴ is methyl, ethyl, n-propyl, isopropyl, or n-butyl, iso-butyl, or tert-butyl.

In certain embodiments, R⁵ is C₁-C₁₀ alkyl, C₁-C₈ alkyl, C₂-C₈ alkyl, C₂-C₆ alkyl, or C₃-C₅ alkyl. In certain embodiments, R⁵ is methyl, ethyl, n-propyl, iso-propyl, or n-butyl, sec-butyl, iso-butyl, tert-butyl, n-pentyl, or n-hexyl.

In certain embodiments, R⁶ is C₁-C₁₀ alkyl, C₁-C₆ alkyl, C₁-C₄ alkyl, C₁-C₃ alkyl, or C₁-C₂ alkyl. In certain embodiments, R⁶ is methyl, ethyl, n-propyl, isopropyl, or n-butyl, iso-butyl, or tert-butyl.

In certain embodiments, R⁴ is C₁-C₃ alkyl or C₁-C₂ alkyl; R⁵ is C₂-C₆ alkyl or C₃-C₅ alkyl; and R⁶ is C₁-C₃ or C₁-C₂ alkyl. In certain embodiments, R⁴ is methyl, R⁵ is n-butyl, and R⁶ is ethyl.

In certain embodiments, the second polymer may further comprises an unreacted propargyl acrylate monomer units represented by the structure:

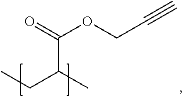

which can result from propargyl groups that do not participate in [3+2] cycloaddition reaction with benzyl azide.

The second polymer may comprises the monomer units:

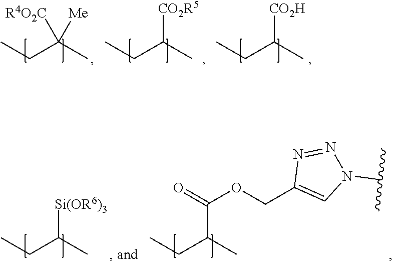

in approximately a 10:10:10:1:1 molar ratio, respectively; 8-12:8-12:8-12:0.8-1.2:0.8-1.2 molar ratio, respectively; 9-11:9-11:9-11:0.9-1.1:0.9-1.1 molar ratio, respectively; 9.5-10.5:9.5-10.5:9.5-10.5:0.95-1.05:0.95-1.05 molar ratio, respectively; 9.75-10.25:9.75-10.25:9.75-10.25:0.975-1.025:0.975-1.025 molar ratio, respectively; or 10:10:10:1:1 molar ratio, respectively.

The third polymer comprises monomer units represented by the structures:

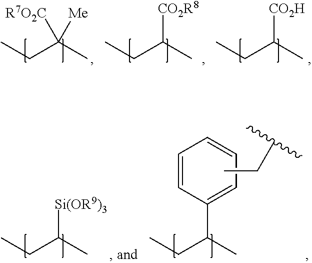

wherein R⁷ is alkyl, R⁸ is alkyl, and each R⁹ is alkyl, wherein

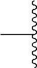

in the second polymer and

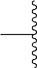

in the third polymer represents a covalent bond therebetween. The third polymer can be a block, alternating, random, regiorandom, or regioregular polymer. The third polymer can be an isotactic polymer, syndiotactic polymer, atactic polymer, or a combination thereof.

In certain embodiments, R⁷ is C₁-C₁₀ alkyl, C₁-C₆ alkyl, C₁-C₄ alkyl, C₁-C₃ alkyl, or C₁-C₂ alkyl. In certain embodiments, R⁷ is methyl, ethyl, n-propyl, isopropyl, or n-butyl, iso-butyl, or tert-butyl.

In certain embodiments, R⁸ is C₁-C₁₀ alkyl, C₁-C₈ alkyl, C₂-C₈ alkyl, C₂-C₆ alkyl, or C₃-C₅ alkyl. In certain embodiments, R⁸ is methyl, ethyl, n-propyl, iso-propyl, or n-butyl, sec-butyl, iso-butyl, tert-butyl, n-pentyl, or n-hexyl.

In certain embodiments, R⁹ is C₁-C₁₀ alkyl, C₁-C₆ alkyl, C₁-C₄ alkyl, C₁-C₃ alkyl, or C₁-C₂ alkyl. In certain embodiments, R⁹ is methyl, ethyl, n-propyl, isopropyl, or n-butyl, iso-butyl, or tert-butyl.

In certain embodiments, R⁷ is C₁-C₃ alkyl or C₁-C₂ alkyl; R⁸ is C₂-C₆ alkyl or C₃-C₅ alkyl; and R⁹ is C₁-C₃ or C₁-C₂ alkyl. In certain embodiments, R⁷ is methyl, R⁸ is n-butyl, and R⁹ is ethyl.

In certain embodiments, the second polymer may further comprises an unreacted benzyl azide monomer unit represented by the structure:

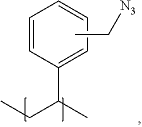

which can result from incomplete [3+2] cycloaddition reaction of the benzyl azide in the third polymer precursor and propargyl groups present in the second polymer precursor.

The monomer unit represented by the structure:

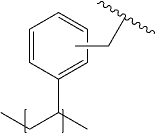

may have an ortho-, meta-, or para-substituted benzene ring as depicted below:

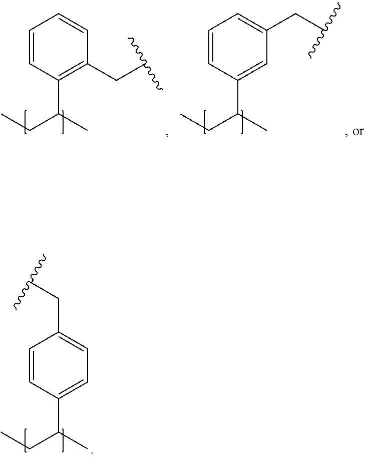

The covalent bond between present between monomers of the second polymer and the third polymer can be represented by the moiety shown below:

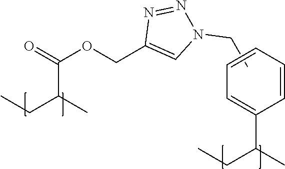

The third polymer may comprises the monomer units:

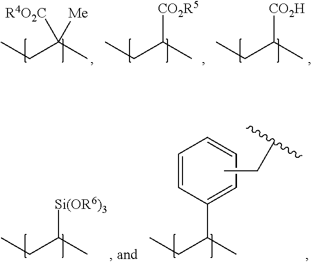

in approximately a 10:10:10:1:1 molar ratio, respectively; 8-12:8-12:8-12:0.8-1.2:0.8-1.2 molar ratio, respectively; 9-11:9-11:9-11:0.9-1.1:0.9-1.1 molar ratio, respectively; 9.5-10.5:9.5-10.5:9.5-10.5:0.95-1.05:0.95-1.05 molar ratio, respectively; 9.75-10.25:9.75-10.25:9.75-10.25:0.975-1.025:0.975-1.025 molar ratio, respectively; or 10:10:10:1:1 molar ratio, respectively.

Crosslinking between the first polymer and the second polymer can occur one or more times between the same polymer molecules or multiple times with the same or different polymer molecules. The extent of crosslinking between the can dependent on a number of different parameters, such as the molar ratio of the monomer units containing the crosslinking functionality (i.e., the benzyl amide and propargyl group) relative to the monomer units present in the second polymer and the third polymer, the molecular weight of the polymers, the concentration and relative amounts of the first polymer and the second polymer in the crosslinking [3+2] cycloaddition step, and the conditions of the reaction conditions and reaction time for the crosslinking [3+2] cycloaddition step.

The second polymer and the third polymer may be present in the second layer in any molar ratio. For example, the second polymer and the third polymer can be present at a 1:100 to 100:1 molar ratio. In certain embodiments, the second polymer and the third polymer can be present ata 10:1 to 1:10; 5:1 to 1:5; 3:1 to 1:3; 2:1 to 1:2; or approximately 1:1.

The components of the first layer can be prepared using any method known to those of skill in the art.

The polymers and polymer precursors described herein can be prepared using any method known in the art. In certain embodiments, the polymers and polymer precursors described herein are prepared by radical polymerization. In certain embodiments, the radical polymerization reaction is an emulsion polymerization using a water soluble radical initiator. Exemplary radical initiators include, but are not limited to a persulphate salts, such as lithium, sodium, potassium, magnesium calcium, and ammonium persulphate salts; and diazo compound, such as 4,4′-azobis(4-cyanovaleric acid); 2,2′-azobis(2-methylpropionamidine)dihydrochloride; 2,2′-azobis[2-(2-imidazolin-2-yl)propane]dihydrochloride; and 2,2′-azobis[2-methyl-N-(2-hydroxyethyl)propionamide]; 2,2′-azobis[2-(2-imidazolin-2-yl)propane].

The first polymer can be prepared in a two-step process in which first polymer vinylic compounds represented by the structures:

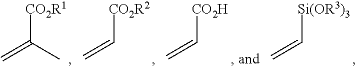

wherein R¹ is alkyl, R² is alkyl, and R³ is alkyl are subjected radical polymerization; thereby forming a first polymer precursor comprising monomer units represented by the structures:

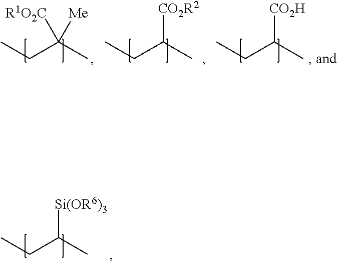

wherein R¹, R², and R³ are as defined in the first polymer vinylic compounds. The first polymer precursor is then condensed with colloidal silica thereby forming the first polymer.

In certain embodiments of the first polymer vinylic compounds, R¹ is C₁-C₁₀ alkyl, C₁-C₆ alkyl, C₁-C₄ alkyl, C₁-C₃ alkyl, or C₁-C₂ alkyl. In certain embodiments of the first polymer vinylic compounds, R¹ is methyl, ethyl, n-propyl, isopropyl, or n-butyl, iso-butyl, or tert-butyl.

In certain embodiments of the first polymer vinylic compounds, R² is C₁-C₁₀ alkyl, C₁-C₈ alkyl, C₂-C₈ alkyl, C₂-C₆ alkyl, or C₃-C₅ alkyl. In certain embodiments, R² is methyl, ethyl, n-propyl, iso-propyl, or n-butyl, sec-butyl, iso-butyl, tert-butyl, n-pentyl, or n-hexyl.

In certain embodiments of the first polymer vinylic compounds, R³ is C₁-C₁₀ alkyl, C₁-C₆ alkyl, C₁-C₄ alkyl, C₁-C₃ alkyl, or C₁-C₂ alkyl. In certain embodiments of the first polymer vinylic compounds, R³ is methyl, ethyl, n-propyl, isopropyl, or n-butyl, iso-butyl, or tert-butyl.

In certain embodiments of the first polymer vinylic compounds, R¹ is C₁-C₃ alkyl or C₁-C₂ alkyl; R² is C₂-C₆ alkyl, or C₃-C₅ alkyl; and R³ is C₁-C₃ alkyl or C₁-C₂ alkyl. In certain embodiments, R¹ is methyl; R² is n-butyl; and R³ is ethyl.

The colloidal silica gel can be formed using any method known to those of skill in the art. In the examples below, the colloidal silica is prepared by hydrolysis and condensation of tetra alkyl orthosilicates. Suitable tetraalkyl orthosilicates include C₁-C₆ tetraalkyl orthosilicates. Exemplary tetraalkyl orthosilicates include, but are not limited to, tetramethyl orthosilicates, tetraethyl orthosilicates, tetrapropyl orthosilicates, and tetrabutyl orthosilicates.

The tetraalkyl orthosilicate can be hydrolysis and condensation can be conducted in an aqueous solution under basic or acidic conditions. In certain embodiments, the hydrolysis and condensation of the tetraalkyl orthosilicate is conducted in an aqueous solution of ammonia.

The colloidal silica gel can be condensed with the first polymer precursor using well known methods. In the examples below, the colloidal silica gel is condensed with the first polymer under aqueous alkaline conditions. The first polymer and the colloidal silica can be combined in any mass ratio. In certain embodiments, the first polymer and the colloidal silica are combined in a 50:1 to 1:1 mass ratio, respectively; 40:1 to 1:1 mass ratio, respectively; 30:1 to 1:1 mass ratio, respectively; 20:1 to 1:1 mass ratio, respectively; 10:1 to 1:1 mass ratio, respectively; 5:1 to 1:1 mass ratio, respectively; 5:1 to 2:1 mass ratio, respectively; 5:1 to 3:1 mass ratio, respectively; or approximately a 4:1 mass ratio, respectively.

By varying the relative molar ratio of each monomer, polymers having the desired molar ratio of each monomer units can be prepared. In certain embodiments, the first polymer precursor is prepared by radical polymerization of:

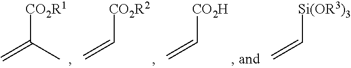

a 10:10:10:1 molar ratio, respectively; 8-12:8-12:8-12:0.8-1.2 molar ratio, respectively; 9-11:9-11:9-11:0.9-1.1 molar ratio, respectively; 9.5-10.5:9.5-10.5:9.5-10.5:0.95-1.05 molar ratio, respectively; 9.75-10.25:9.75-10.25:9.75-10.25:0.975-1.025 molar ratio, respectively; or 10:10:10:1 molar ratio, respectively.

The crosslinked polymer present in the second layer is prepared by the [3+2] cycloaddition reaction of a second polymer precursor and a third polymer precursor.

The second polymer precursor can comprise monomer represented by the structures:

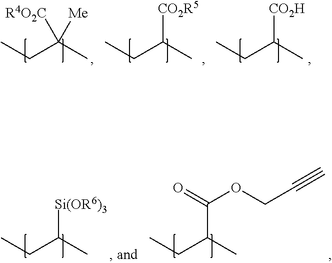

wherein R⁴ is alkyl, R⁵ is alkyl, and each R⁶ is alkyl. In certain embodiments of the second polymer precursor, R⁴ is C₁-C₁₀ alkyl, C₁-C₆ alkyl, C₁-C₄ alkyl, C₁-C₃ alkyl, or C₁-C₂ alkyl. In certain embodiments of the second polymer precursor, R⁴ is methyl, ethyl, n-propyl, isopropyl, or n-butyl, iso-butyl, or tert-butyl.

In certain embodiments of the second polymer precursor, R⁵ is C₁-C₁₀ alkyl, C₁-C₈ alkyl, C₂-C₈ alkyl, C₂-C₆ alkyl, or C₃-C₅ alkyl. In certain embodiments of the second polymer precursor, R⁵ is methyl, ethyl, n-propyl, iso-propyl, or n-butyl, sec-butyl, iso-butyl, tert-butyl, n-pentyl, or n-hexyl.

In certain embodiments of the second polymer precursor, R⁶ is C₁-C₁₀ alkyl, C₁-C₆ alkyl, C₁-C₄ alkyl, C₁-C₃ alkyl, or C₁-C₂ alkyl. In certain embodiments of the second polymer precursor, R⁶ is methyl, ethyl, n-propyl, isopropyl, or n-butyl, iso-butyl, or tert-butyl.

In certain embodiments of the second polymer precursor, R⁴ is C₁-C₃ alkyl or C₁-C₂ alkyl; R⁵ is C₂-C₆ alkyl or C₃-C₅ alkyl; and R⁶ is C₁-C₃ or C₁-C₂ alkyl. In certain embodiments of the second polymer precursor, R⁴ is methyl, R⁵ is n-butyl, and R⁶ is ethyl.

The second polymer precursor can be prepared by radical polymerization of second polymer precursor vinylic compounds represented by the structures:

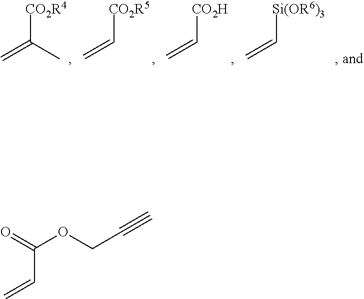

wherein R⁴ is alkyl, R⁵ is alkyl, and each R⁶ is alkyl. In certain embodiments of the second polymer precursor vinylic compounds, R⁴ is C₁-C₁₀ alkyl, C₁-C₆ alkyl, C₁-C₄ alkyl, C₁-C₃ alkyl, or C₁-C₂ alkyl. In certain embodiments of the second polymer precursor vinylic compounds, R⁴ is methyl, ethyl, n-propyl, isopropyl, or n-butyl, iso-butyl, or tert-butyl.

In certain embodiments of the second polymer precursor vinylic compounds, R⁵ is C₁-C₁₀ alkyl, C₁-C₈ alkyl, C₂-C₈ alkyl, C₂-C₆ alkyl, or C₃-C₅ alkyl. In certain embodiments of the second polymer precursor vinylic compounds, R⁵ is methyl, ethyl, n-propyl, iso-propyl, or n-butyl, sec-butyl, iso-butyl, tert-butyl, n-pentyl, or n-hexyl.

In certain embodiments of the second polymer precursor vinylic compounds, R⁶ is C₁-C₁₀ alkyl, C₁-C₆ alkyl, C₁-C₄ alkyl, C₁-C₃ alkyl, or C₁-C₂ alkyl. In certain embodiments of the second polymer precursor vinylic compounds, R⁶ is methyl, ethyl, n-propyl, isopropyl, or n-butyl, iso-butyl, or tert-butyl.

In certain embodiments of the second polymer precursor vinylic compounds, R⁴ is C₁-C₃ alkyl or C₁-C₂ alkyl; R⁵ is C₂-C₆ alkyl or C₃-C₅ alkyl; and R⁶ is C₁-C₃ or C₁-C₂ alkyl. In certain embodiments of the second polymer precursor vinylic compounds, R⁴ is methyl, R⁵ is n-butyl, and R⁶ is ethyl.

By varying the relative molar ratio of each monomer, polymers having the desired molar ratio of each monomer units can be prepared. In certain embodiments, the second polymer precursor is prepared by radical polymerization of:

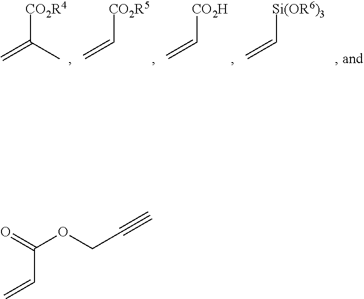

a 10:10:10:1:1 molar ratio, respectively; 8-12:8-12:8-12:0.8-1.2:0.8-1.2 molar ratio, respectively; 9-11:9-11:9-11:0.9-1.1:0.9-1.1 molar ratio, respectively; 9.5-10.5:9.5-10.5:9.5-10.5:0.95-1.05:0.95-1.05 molar ratio, respectively; 9.75-10.25:9.75-10.25:9.75-10.25:0.975-1.025:0.975-1.025 molar ratio, respectively; or 10:10:10:1 molar ratio, respectively.

The third polymer precursor can comprise monomer represented by the structures:

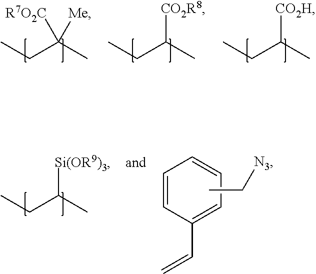

wherein R⁷ is alkyl, R⁸ is alkyl, and each R⁹ is alkyl.

In certain embodiments of the third polymer precursor, R⁷ is C₁-C₁₀ alkyl, C₁-C₆ alkyl, C₁-C₄ alkyl, C₁-C₃ alkyl, or C₁-C₂ alkyl. In certain embodiments of the third polymer precursor, R⁷ is methyl, ethyl, n-propyl, isopropyl, or n-butyl, iso-butyl, or tert-butyl.

In certain embodiments of the third polymer precursor, R⁸ is C₁-C₁₀ alkyl, C₁-C₈ alkyl, 02-C₈ alkyl, C₂-C₆ alkyl, or C₃-C₅ alkyl. In certain embodiments of the third polymer precursor, R⁸ is methyl, ethyl, n-propyl, iso-propyl, or n-butyl, sec-butyl, iso-butyl, tert-butyl, n-pentyl, or n-hexyl.

In certain embodiments of the third polymer precursor, R⁹ is C₁-C₁₀ alkyl, C₁-C₆ alkyl, C₁-C₄ alkyl, C₁-C₃ alkyl, or C₁-C₂ alkyl. In certain embodiments of the third polymer precursor, R⁹ is methyl, ethyl, n-propyl, isopropyl, or n-butyl, iso-butyl, or tert-butyl.

In certain embodiments of the third polymer precursor, R⁷ is C₁-C₃ alkyl or C₁-C₂ alkyl; R⁸ is C₂-C₆ alkyl or C₃-C₅ alkyl; and R⁹ is C₁-C₃ or C₁-C₂ alkyl. In certain embodiments of the third polymer precursor, R⁷ is methyl, R⁸ is n-butyl, and R⁹ is ethyl.

The third polymer precursor can be prepared by radical polymerization of third polymer precursor vinylic compounds represented by the structures:

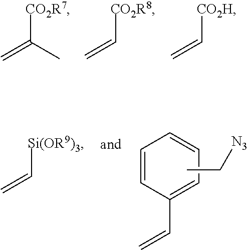

wherein R⁷ is alkyl, R⁸ is alkyl, and each R⁹ is alkyl.

In certain embodiments of the third polymer precursor vinylic compounds, R⁷ is C₁-C₁₀ alkyl, C₁-C₆ alkyl, C₁-C₄ alkyl, C₁-C₃ alkyl, or C₁-C₂ alkyl. In certain embodiments of the third polymer precursor vinylic compounds, R⁷ is methyl, ethyl, n-propyl, isopropyl, or n-butyl, iso-butyl, or tert-butyl.

In certain embodiments of the third polymer precursor vinylic compounds, R⁸ is C₁-C₁₀ alkyl, C₁-C₈ alkyl, C₂-C₈ alkyl, C₂-C₆ alkyl, or C₃-C₅ alkyl. In certain embodiments of the third polymer precursor vinylic compounds, R⁸ is methyl, ethyl, n-propyl, iso-propyl, or n-butyl, sec-butyl, iso-butyl, tert-butyl, n-pentyl, or n-hexyl.

In certain embodiments of the third polymer precursor vinylic compounds, R⁹ is C₁-C₁₀ alkyl, C₁-C₆ alkyl, C₁-C₄ alkyl, C₁-C₃ alkyl, or C₁-C₂ alkyl. In certain embodiments of the third polymer precursor vinylic compounds, R⁹ is methyl, ethyl, n-propyl, isopropyl, or n-butyl, iso-butyl, or tert-butyl.

In certain embodiments of the third polymer precursor vinylic compounds, R⁷ is C₁-C₃ alkyl or C₁-C₂ alkyl; R⁸ is C₂-C₆ alkyl or C₃-C₅ alkyl; and R⁹ is C₁-C₃ or C₁-C₂ alkyl. In certain embodiments of the third polymer precursor vinylic compounds, R⁷ is methyl, R⁸ is n-butyl, and R⁹ is ethyl.

By varying the relative molar ratio of each monomer, polymers having the desired molar ratio of each monomer units can be prepared. In certain embodiments, the third polymer precursor is prepared by radical polymerization of:

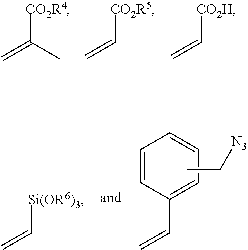

a 10:10:10:1:1 molar ratio, respectively; 8-12:8-12:8-12:0.8-1.2:0.8-1.2 molar ratio, respectively; 9-11:9-11:9-11:0.9-1.1:0.9-1.1 molar ratio, respectively; 9.5-10.5:9.5-10.5:9.5-10.5:0.95-1.05:0.95-1.05 molar ratio, respectively; 9.75-10.25:9.75-10.25:9.75-10.25:0.975-1.025:0.975-1.025 molar ratio, respectively; or 10:10:10:1 molar ratio, respectively.

The second polymer precursor and the third polymer precursor can be crosslinked during application in situ under conditions for facilitating the [3+2] cycloaddition reaction of the azide and propargyl group thereby forming the crosslinked polymer. The second polymer precursor and the third polymer precursor may be present in the [3+2] cycloaddition reaction in any molar ratio. For example, the second polymer precursor and the third polymer precursor can be present at a 1:100 to 100:1 molar ratio in the [3+2] cycloaddition reaction. In certain embodiments, the second polymer precursor and the third polymer precursor can be present at a 10:1 to 1:10; 5:1 to 1:5; 3:1 to 1:3; 2:1 to 1:2; or approximately 1:1 in the in the [3+2] cycloaddition reaction.

The [3+2] cycloaddition reaction can be facilitated by the presence of a copper salt in the [3+2] cycloaddition reaction and/or subjecting the [3+2] cycloaddition reaction to heat. The copper salt, can be any copper salt known in the art. The copper salt is typically a Cu(I) salt. The Cu(I) salt can be prepared in situ by reduction of a Cu(II) salt. Exemplary copper salts include, but are not limited to chloride, bromide, iodide, nitrate, sulfate, phosphate, cyanide, and combinations thereof. The copper salt can be a Cu(I) or Cu(II) salt comprising one or more anions selected from the group consisting of chloride, bromide, iodide, nitrate, sulfate, phosphate, cyanide, and acetate. In certain embodiments, the copper salt is Cu(II)SO₄ and sodium ascorbate is used as a reductant to generate Cu(I) in situ.

The carbon additive may present in the [3+2] cycloaddition reaction. In certain embodiments, the carbon additive is selected from the group consisting of graphene, graphite, carbon black, carbon nanotubes, and combinations thereof.

The coating composition can be applied substrate by contacting the surface of the substrate with a first composition comprising colloidal silica and a first polymer comprising monomer units represented by the structures:

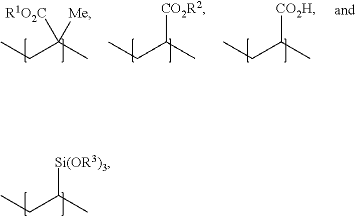

wherein R¹ is alkyl, R² is alkyl, and each R³ is independently hydrogen or an oxygen-silicon covalent bond to at least a portion of the colloidal silica thereby forming a first layer disposed on top of the substrate; contacting the surface of the first layer with a second composition comprising a carbon additive, a second polymer precursor, and a third polymer precursor, wherein the second polymer precursor comprises monomer units represented by the structures:

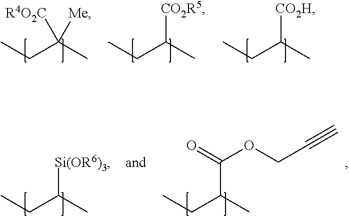

wherein R⁴ is alkyl, R⁵ is alkyl, and each R⁶ is alkyl; and the third polymer precursor comprises monomer units represented by the structures:

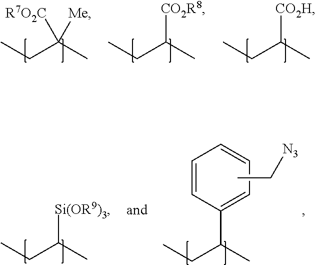

wherein R⁷ is alkyl, R⁸ is alkyl, and each R⁹ is alkyl thereby forming a thin film disposed on top of the first layer; and subjecting the thin film to a condition for facilitating the [3+2] cycloaddition reaction of the second polymer precursor and the third polymer precursor thereby forming the second layer comprising the crosslinked polymer.

In certain embodiments, the first composition and the second composition are aqueous emulsions.

In certain embodiments, after the formation of the first layer disposed on top of the substrate, the first layer is cured. The curing temperature can be at any temperature between 40-150° C. In certain embodiments, the curing temperature is between 40-150° C.; 40-140° C.; 40-130° C.; 40-120° C.; 40-110° C.; 40-100° C.; 40-90° C.; 50-90° C.; 60-90° C.; 60-80° C.; or 65- 75° C. The first layer disposed on top of the substrate can be cured for up to 60 min, up to 50 min, up 40 min, up to 30 min, up to 20 min, up to 15 min, or up to 10 min. In certain embodiments, the first layer disposed on top of the substrate can be cured for 3-20 min, 3-15 min, or 5-15 min.

In certain embodiments, the condition for facilitating the [3+2] cycloaddition reaction comprises subjecting the reaction to heat at any temperature between 40-150° C. In certain embodiments, the reaction is heated at a temperature between 40-150° C.; 40-140° C.; 40-130° C.; 40-120° C.; 40-110° C.; 40-100° C.; 40-90° C.; 50-90° C.; 60-90° C.; 60-80° C.; or 65-75° C. In certain embodiments, the reaction is heated for up to 60 min, up to 50 min, up 40 min, up to 30 min, up to 20 min, up to 15 min, or up to 10 min. In certain embodiments the [3+2] cycloaddition reaction is heated for 3-20 min, 3-15 min, or 5-15 min. In certain embodiments, after subjecting the [3+2] cycloaddition reaction the second layer is kept at room temperature for between 1 hr and 48 hr; 12 hr and 48 hr; 12 hr and 36 hr; 18 hr and 36 hr; 18 hr and 30 hr; or approximately 24 hr.

Also provided herein are kits useful for preparing the coating compositions described herein. In certain embodiments, the kit comprises a first container comprising colloidal silica and a first polymer comprising monomer units represented by the structures:

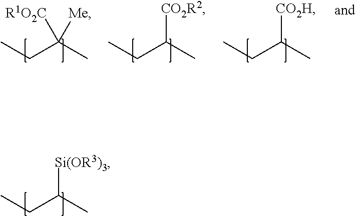

wherein R¹ is alkyl, R² is alkyl, and each R³ is independently hydrogen or an oxygen-silicon covalent bond to at least a portion of the colloidal silica; a second contacting comprising a second polymer precursor comprising monomer units represented by the structures:

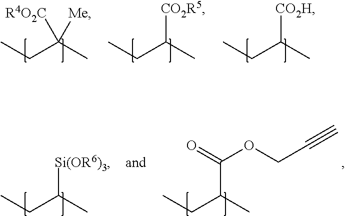

wherein R⁴ is alkyl, R⁵ is alkyl, and each R⁶ is alkyl; and a third container comprising a third polymer precursor comprising monomer units represented by the structures:

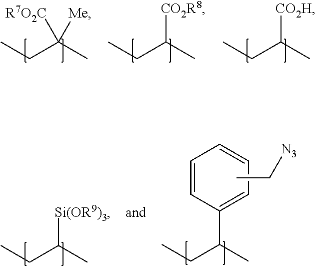

wherein R⁷ is alkyl, R⁸ is alkyl, and each R⁹ is alkyl.

The first container may further comprise an aqueous solvent. In certain embodiments, the first container further comprises an adhesion promoter, such as Trapylen 9600W.

The second container may further comprise an aqueous solvent. In certain embodiments, the second container further comprises sodium bicarbonate, sodium dodecyl sulphate, and Triton X-100.

The third container may further comprise an aqueous solvent. In certain embodiments, the third container further comprises sodium bicarbonate, sodium dodecyl sulphate, and Triton X-100.

In certain embodiments, at least one of the second container or the third container further comprises a carbon additive as described herein.

In certain embodiments, the kit further comprises a fourth contain comprising a copper salt. The copper salt can be a Cu(I) or Cu(II) salt comprising one or more anions selected from the group consisting of chloride, bromide, iodide, nitrate, sulfate, phosphate, cyanide, and acetate.

Polypropylene based polymer substrates (such as used in airbag covers) tend to be non-polar with low surface energy, whereas traditional waterborne coatings have high surface energy. This large surface energy difference can result in coatings with poor wettability on the substrate, resulting in film formation problem. Therefore, in this project, a first polymer is developed to enhance the adhesion between the crosslinked polymer on substrates, such as PP-EPDM airbags.

The first layer can be prepared by direct blending of waterborne first polymer and colloidal silica. The colloidal silica can be used as an inorganic filler, which can improve the hardness of the first layer.

The recipe for the preparation of first polymer is displayed as below:

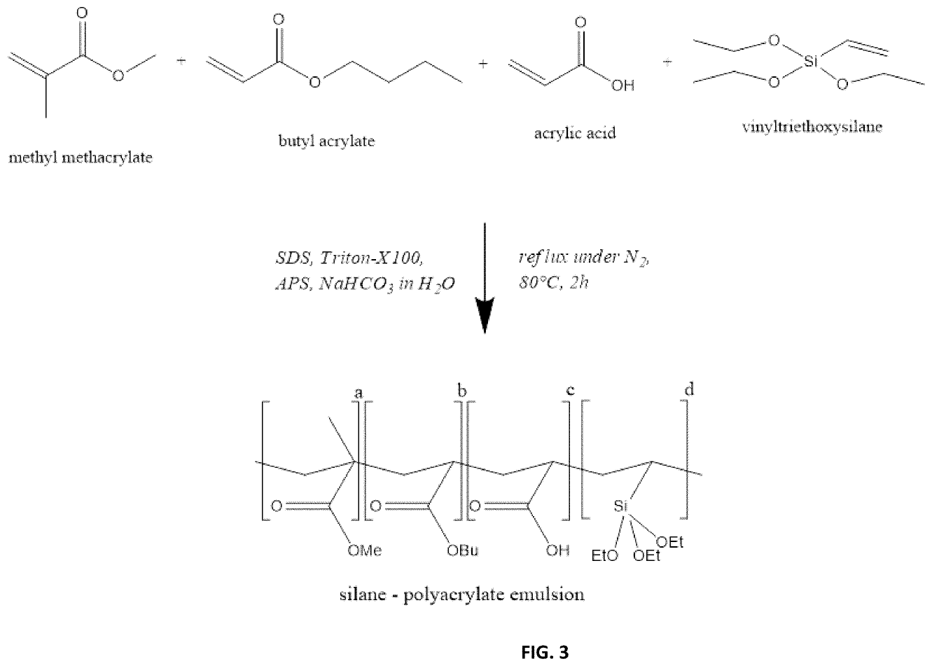

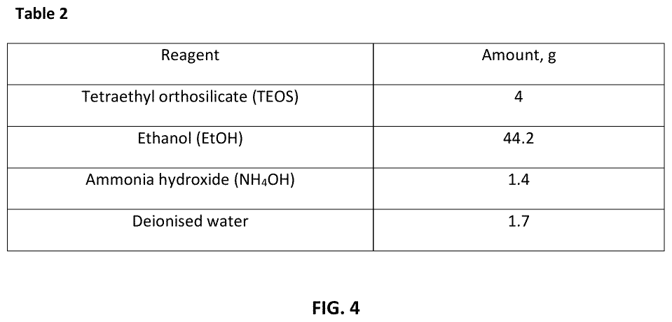

The waterborne first polymer was prepared according to Table 1 using the following procedure. First, a solution consisted of 40% of the total volume of sodium dodecyl sulphate, Triton X-100, ammonium persulphate, sodium bicarbonate and deionised water were charged into a 3-neck round bottom flask with a mechanical stirrer, condenser and nitrogen inlet. Meanwhile, the remaining 60% of sodium bicarbonate, sodium dodecyl sulphate, Triton X-100, ammonium persulphate, and deionised water were vigorously and homogeneously mixed with all the monomers to form a pre-emulsion. The solution in the flask was heated to 80° C. under nitrogen and the pre-emulsion was added into it to start the free-radical polymerisation at 500 rpm stirring. The addition of the pre-emulsion into the flask was at the rate of 3 mL/min. The reaction was allowed to continue for 2 hour at 80° C. under nitrogen and extra of water may require adding into the reaction mixture in order to compensate the water loss from evaporation. The mixture was cooled to room temperature and milky first polymer precursor was obtained. The solid content of the PAE shall be 40 (±2) wt %. The synthetic route of preparation of polyacrylate emulsion was shown in FIG. 3.

The colloidal silica was prepared according to Table 2 using the following procedure. First, a solution consisted of ammonia hydroxide, deionised water and 80% of total amount of ethanol were charged into a round bottom flask with a mechanical stirrer. Meanwhile, tetraethyl orthosilicate and the remaining 20% of ethanol were homogenously mixed. The solution in the flask was heated to 60° C. and the tetraethyl orthosilicate solution was added into it to start the hydrolysis and condensation reaction at 500 rpm stirring. The addition of the tetraethyl orthosilicate solution into the flask was at the rate of 2 mL/min. The reaction was allowed to continue for 3 hour at 60° C. The mixture was cooled to room temperature and translucent colloidal silica was obtained. The reaction mechanism of preparation of colloidal silica was shown in FIG. 5.

The first composition comprising the first polymer and colloidal silica was prepared by a direct blending of the first polymer precursor and colloidal silica in a 4:1 w/w ratio. The pH of PAE was first adjusted to 8 by using 1M of sodium hydroxide and then it was homogeneously mixed with the colloidal silica at room temperature by using a magnetic stirrer. When combining the first polymer precursor and colloidal silica in alkaline condition, the Si—OH groups of silica could be grafted onto the surface of the first polymer precursor by hydrolysis and condensation between the —Si(OEt) functional groups from the first polymer precursor side chains and the silica, forming a higher degree of crosslinking network as illustrated in FIG. 6.

4% of Trapylen 9600W the adhesion promoter was also added into the first composition to further reduce the surface energy difference between the primer and the substrate. The mass ratio of the first polymer precursor to colloidal silica to Trapylen 9600W used to prepare the first composition solution was 4:1:0.2 by weight. The first composition solution was then directly applied onto the PP-EPDM airbag cover by air-compressed spraying. The spraying condition was set as 10 mL/min and 0.15 MPa. The coating was cured at 70° C. for 10 min followed by the application of top layer coating.

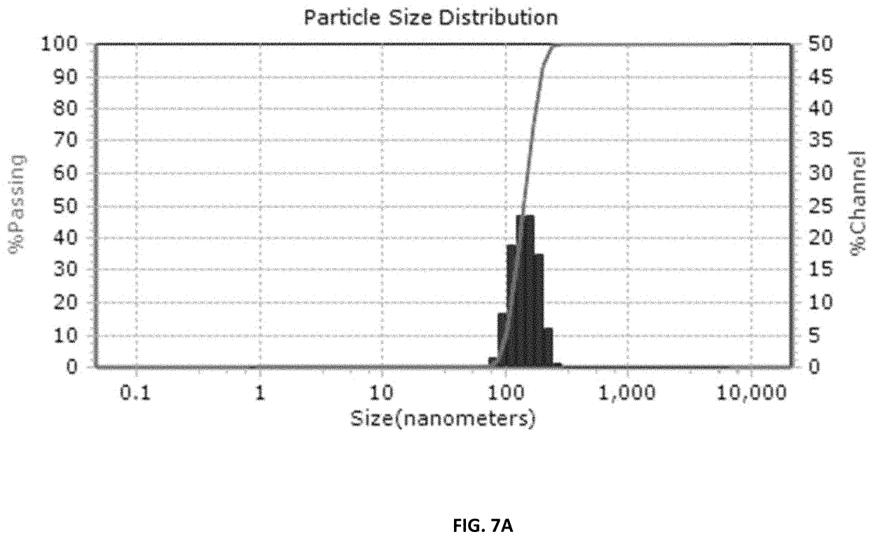

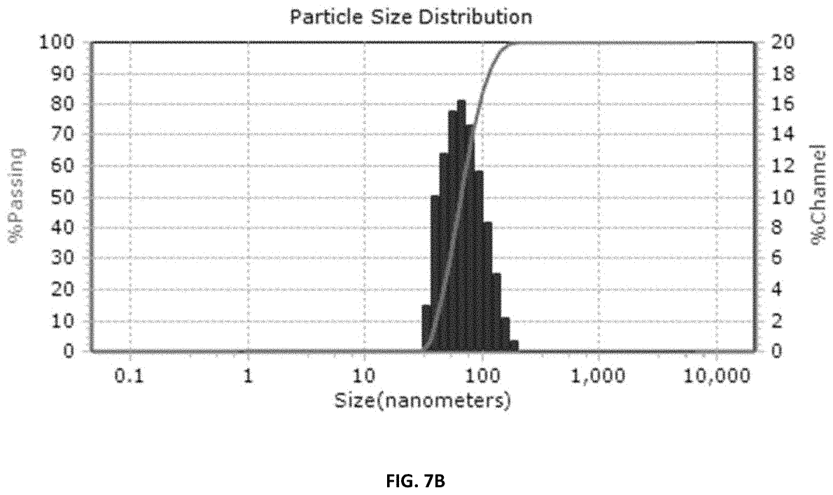

The particle size and distribution of the first polymer and the colloidal silica were determined by dynamic light scattering (DLS) from Microtrac. The particle size of the first polymer was around 120 nm with 0.363 PDI and that of the silica was around 50 nm with 0.953 PDI, in which their particle size distribution graphs were shown as FIGS. 7(a) and 7(b) respectively.

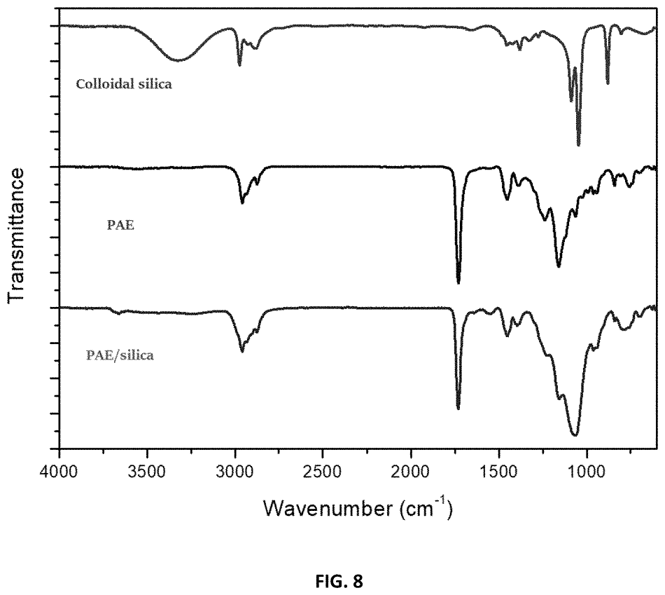

The chemical structure of the first polymer emulsion, colloidal silica and the primer solution were characterised by Fourier transform infrared spectra (FTIR) from Bruker. As shown in FIG. 8, the spectra of silica showed a board absorption peak at 3320 cm⁻¹ which was associated with the stretching vibrations of Si—OH group, while the peaks appeared at 1045 cm⁻¹ and 879 cm⁻¹ were attributed to the stretching vibrations of Si—O—Si groups. The stretching vibration of Si—O—Si group could also be found in the spectra of primer solution which appeared at 1058 cm⁻¹, however, the Si—OH peak disappeared in the primer spectra. It was believed that all the Si—OH occurred to form Si—O—Si crosslinking bonds during the drying process of primer coating, and therefore the Si—O—Si peak was broaden than that in the silica spectra. The characteristic stretching peaks of C—H groups at 2820-3000 cm⁻¹ could be seen in all spectrum. The C—H groups in the silica spectra were believed to be coming from the ethanol while in first polymer and primer spectrum were related to methyl methacrylate, butyl acrylate and acrylic acid moieties. Again, the absorption peaks at around 1730 cm⁻¹ and 1150 cm⁻¹ are attributed to the stretching vibrations of C═O and C—O—C groups from the methyl methacrylate (MMA), butyl acrylate (BA) and acrylic acid (AA) moieties.

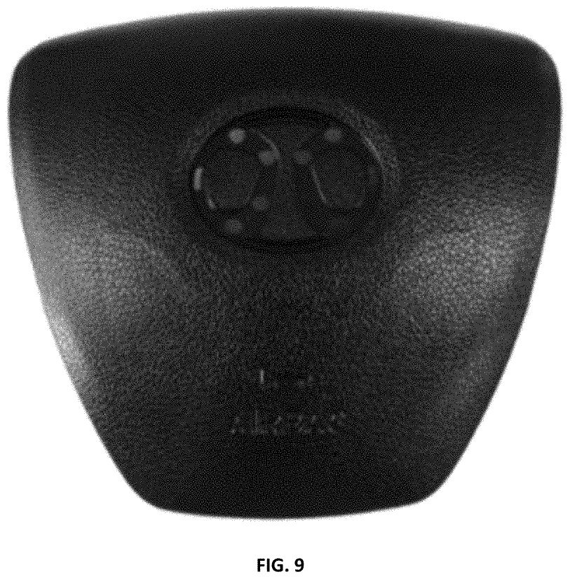

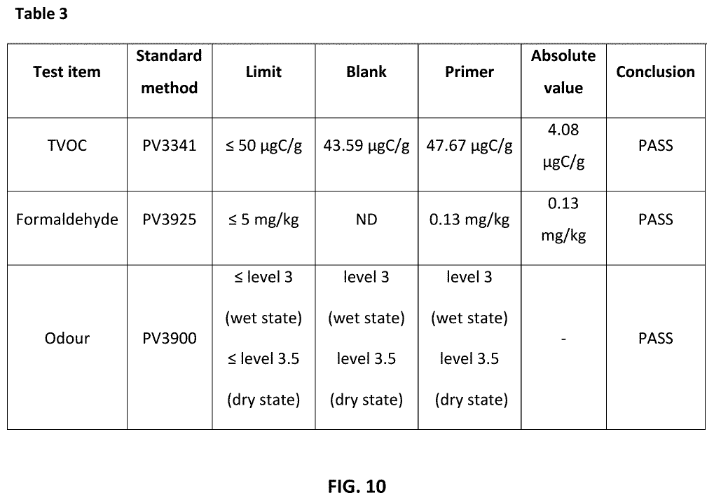

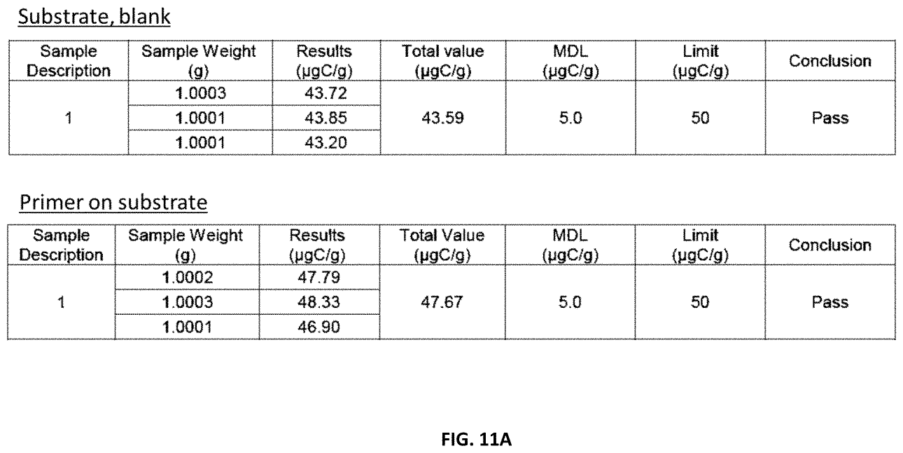

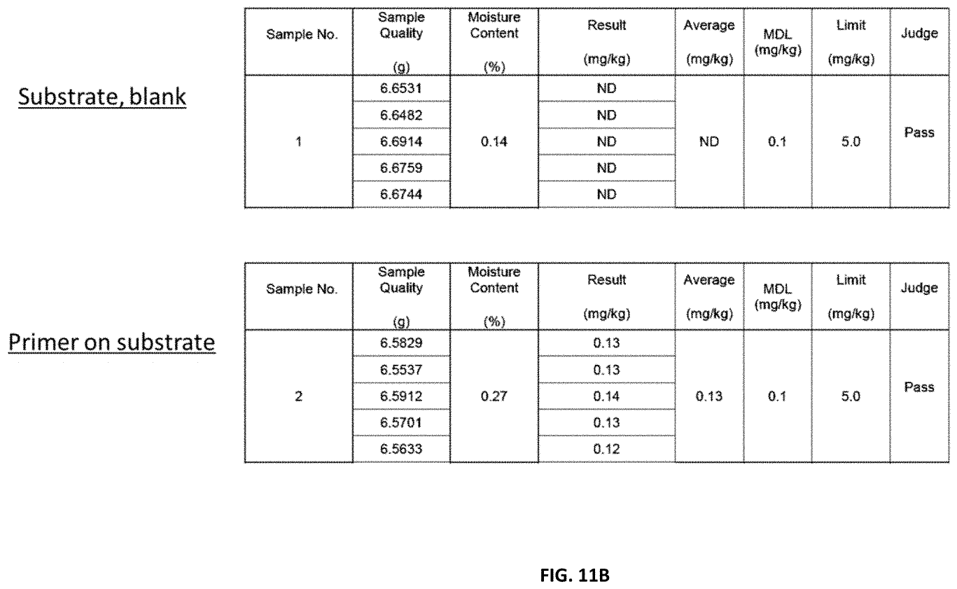

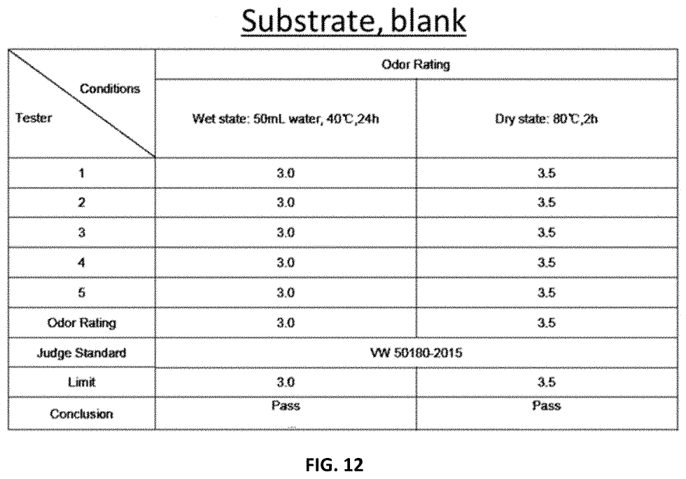

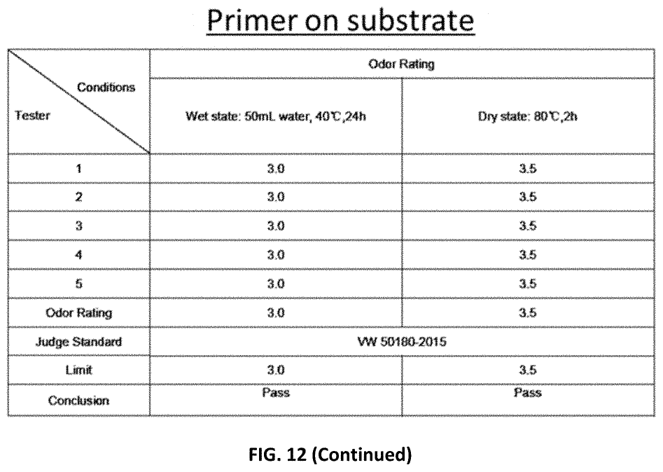

The primer solution was first sprayed on the PP-EPDM substrate (FIG. 9) to determine the coating performance which includes thickness, hardness as well as the volatile organic compounds (VOC) emission. The primer coating thickness was around 10 μm and the hardness was 5B by pencil hardness measurement. Coating samples were sent to third-party testing laboratory for the VOC emission tests based on the test standard VW 50180. Total of three test items of the VOC emission were carried out: total volatile organic compound (TVOC) test to determine the total amount of volatile organic compound emitted from the coating, emission of formaldehyde test to determine the total amount of HCOH emitted from the coating and odour test to determine the odour resulting from the climatic exposure from the coating. All the results were summarised in Table 3 and the test reports were displayed in FIGS. 11 & 12. All the VOC test results of the primer coating were able to comply with the test standard VW 50180.

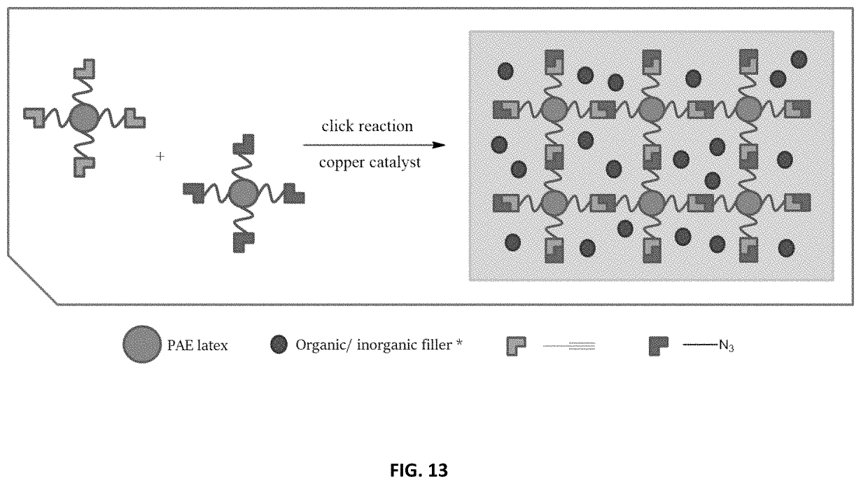

In order to further enhance the crosslinking degree of the silane-polyacrylate latex and thus the overall film properties of the coating, a click reaction was introduced to prepare the second layer of the coating composition. As seen in FIG. 13, click-suitable alkyne- and azide-containing monomers were selected to be incorporated into the silane-polyacrylate emulsions to form PAE with alkyne and azide side chain. PAE with alkyne (PAE-al) and azide (PAE-az) side chain would then undergo click reaction in the presence of copper catalyst.

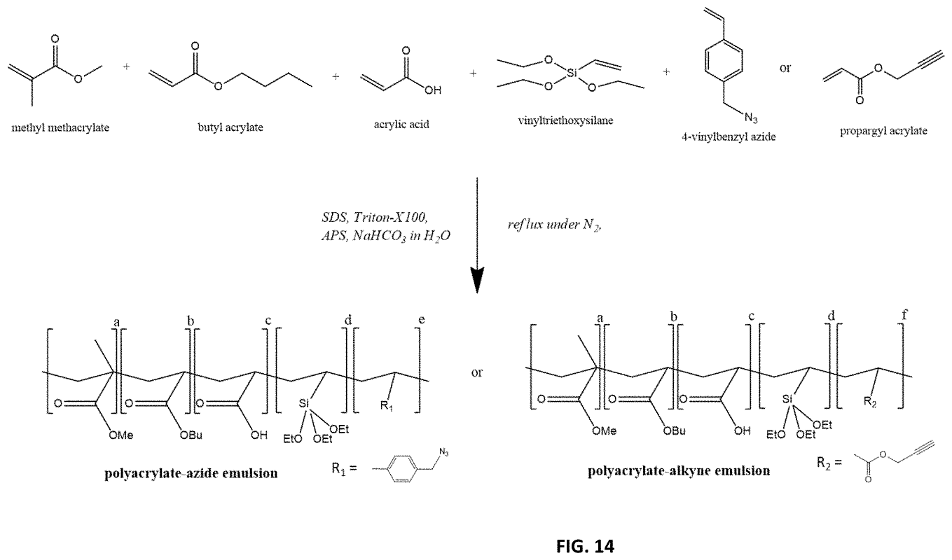

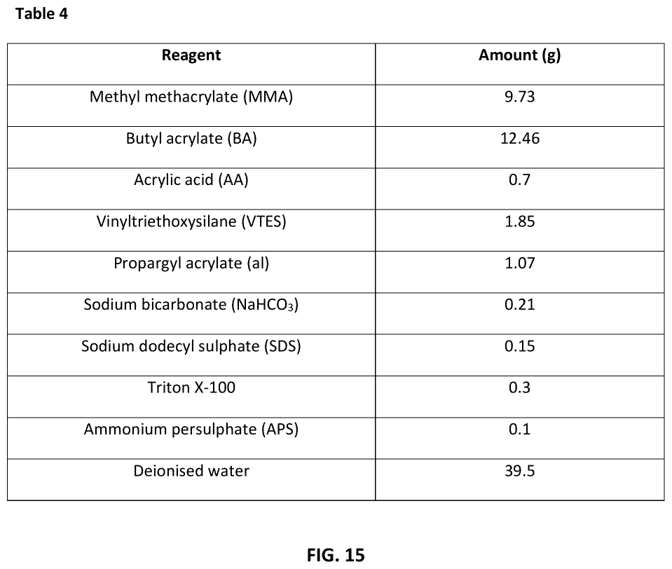

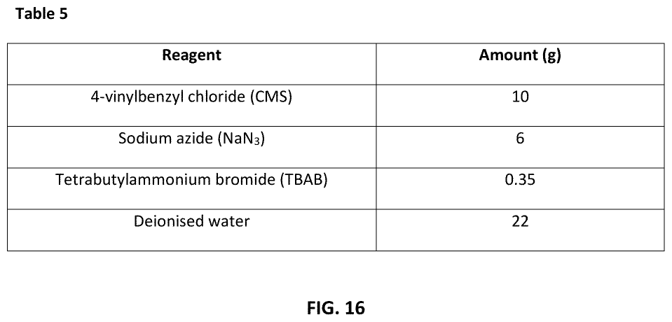

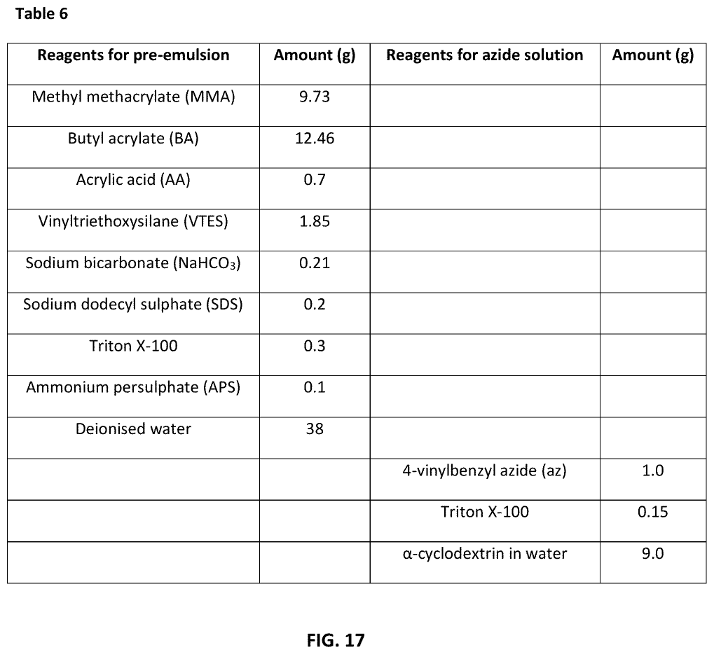

The second layer is prepared by a click reaction between waterborne silane-polyacrylate latex/emulsion with alkyne (PAE-al—second polymer precursor) and azide (PAE-az—third polymer precursor) side chains. The main matrix of PAE-al and PAE-az were similar to the PAE in primer solution which was a copolymerisation of monomers of methyl methacrylate, butyl acrylate, acrylic acid and vinyltriethoxysilane, but an extra monomer of propargyl acrylate and 4-vinylbenzyl azide was introduced respectively. The synthetic route of preparation of PAE-al and PAE-az was shown in FIG. 14.

The recipe for the preparation of PAE-al is displayed as below:

The waterborne silane-polyacrylate latex with alkyne side chain was prepared according to Table 4 using the following procedure. First, a solution consisted of 40% of the total volume of sodium dodecyl sulphate, Triton X-100, ammonium persulphate, sodium bicarbonate and deionised water were charged into a 3-neck round bottom flask with a mechanical stirrer, condenser and nitrogen inlet. Meanwhile, the remaining 60% of sodium bicarbonate, sodium dodecyl sulphate, Triton X-100, ammonium persulphate, and deionised water are vigorously and homogeneously mixed with all the monomers to form a pre-emulsion. The solution in the flask was heated to 80° C. under nitrogen and the pre-emulsion was added into it to start the free-radical polymerisation at 500 rpm stirring. The addition of the pre-emulsion into the flask was at the rate of 3 mL/min. The reaction was allowed to continue for 1 hour at 80° C. under nitrogen and extra of water may require adding into the reaction mixture in order to compensate the water loss from evaporation. The mixture was cooled to room temperature and light milky PAE was obtained. The solid content of the PAE-al shall be 40 (±2) wt %.

For the silane-polyacrylate latex with azide side chain, monomer of 4-vinylbenzyl azide had to be synthesised according to Table 5 using the following procedure. First, a solution consisted of sodium azide, tetrabutylammonium bromide and deionised water were charged into a 3-neck bottom flask with a mechanical stirrer and nitrogen inlet and outlet. The solution in flask was heated to 55° C. under nitrogen and 4-vinylbenzyl chloride was added into it to start the reaction. The addition of the CMS into the flask was at the rate of 1 mL/min. The reaction mixture was allowed to continue for 4 hour at 55° C. under nitrogen. Then 20 mL of cold water was poured into the reaction mixture and the final product of 4-vinylbenzyl azide was extracted with 40 mL of dichloromethane (DCM) three times. Since the desired product dissolved in the organic solvent, the combined organic phase was therefore dried over by anhydrous magnesium sulphate followed by the removal of DCM using a rotary evaporator. 4-vinylbenzyl azide was obtained as a dark yellow liquid.

The waterborne silane-polyacrylate latex with azide side chain was prepared according to Table 6 using the following procedure. First, a solution consisted of 40% of the total volume of sodium dodecyl sulphate, Triton X-100, ammonium persulphate, sodium bicarbonate and deionised water were charged into a 3-neck round bottom flask with a mechanical stirrer, condenser and nitrogen inlet. Meanwhile, the remaining 60% of sodium bicarbonate, sodium dodecyl sulphate, Triton X-100, ammonium persulphate, and deionised water were vigorously and homogeneously mixed with all the monomers (column 1-2) to form a pre-emulsion. The solution in the flask was heated to 80° C. under nitrogen and the pre-emulsion was added into it to start the free-radical polymerisation at 500 rpm stirring. The addition of the pre-emulsion into the flask was at the rate of 3 mL/min. The reaction was allowed to continue for 40 min at 80° C. under nitrogen. After that, a solution consisted of 4-vinylbenzyl azide, Triton X-100 and deionised water (column 3-4) were homogeneously mixed by sonication and it was added into the flask at 2 mL/min after the pre-emulsion was refluxed for 40 min. The whole reaction was allowed to continue for further 20 min at 80° C. under nitrogen. During the reflux, extra of water may require adding into the reaction mixture in order to compensate the water loss from evaporation. The mixture was cooled to room temperature and yellowish milky PAE-az was obtained. The solid content of the PAE-al shall be 40 (±2) wt %.

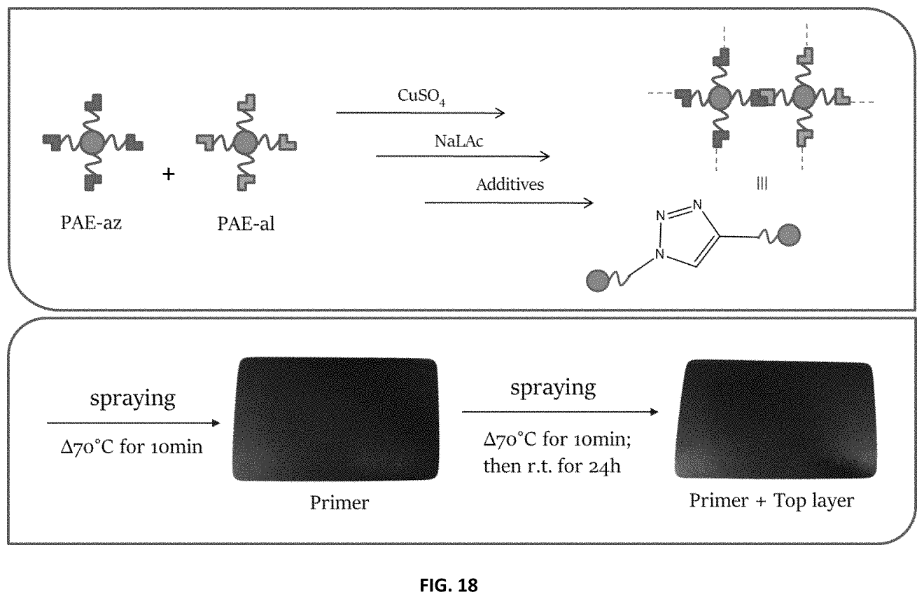

The click reaction of top layer coating was conducted as follows: 5 g of PAE-al and 5 g of PAE-az were first mixed together and a solution of 4×10⁻³ g of copper sulphate (CuSO₄) in 1 mL of deionised water was added into the mixture. Then a solution of 0.02 g of sodium L-ascorbate (NaLAc) in 1 mL of deionised water was added into the mixture to initiate the click reaction. The click mixture was allowed to be stirred for an hour. After that 0.25 mL of 5% wt/wt % graphene aqueous dispersion and 0.3 g Silok 9137W were added into the mixture before getting ready for application. The top layer solution was then directly applied onto the primer-coated PP-EPDM airbag cover by air-compressed spraying. The spraying condition was set as 10 mL/min and 0.15 MPa. The dual coating was cured at 70° C. for 10 min followed by air-dried for 24 hour. The fabrication process of the click reaction between PAE-al and PAE-az and dual layer coating were illustrated in FIG. 18.

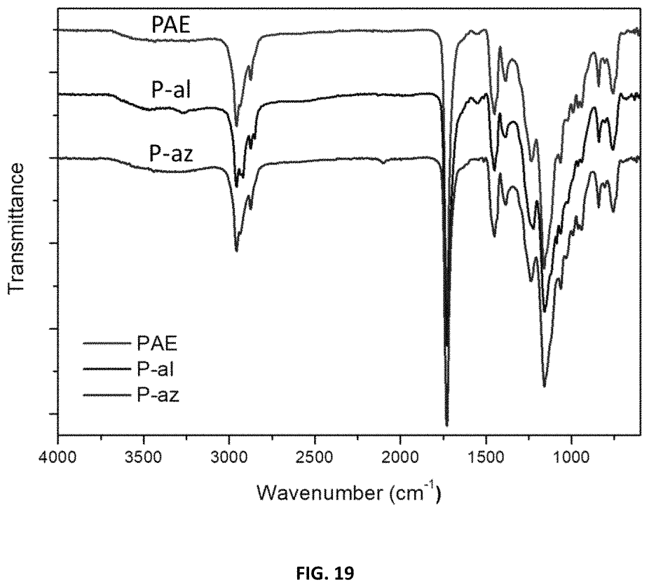

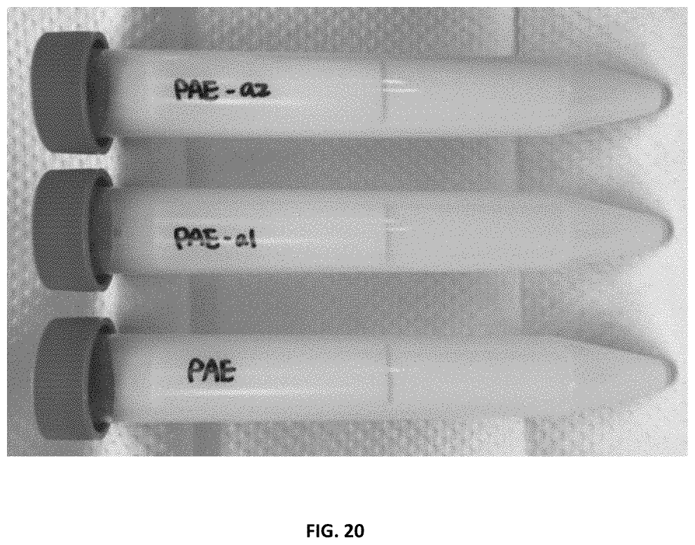

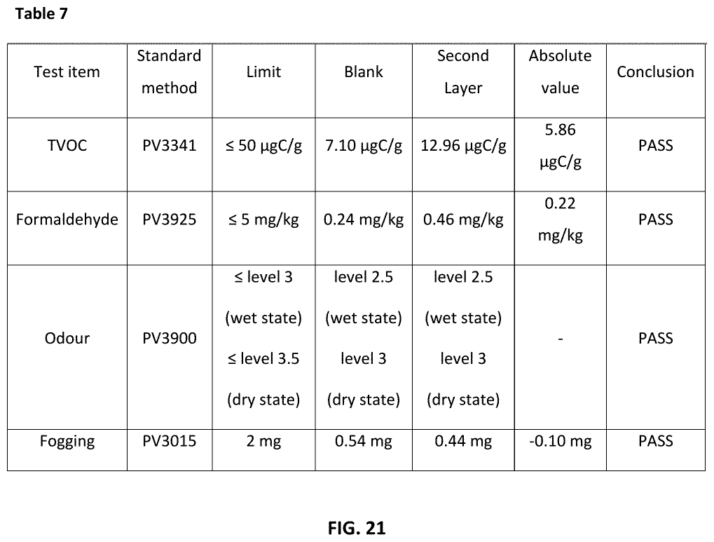

The chemical structure of the silane-polyacrylate emulsion with alkyne and azide side chain, clicked PAE and 4-vinylbenzyl azide were characterised by Fourier transform infrared spectra (FTIR) from Bruker. All three spectrum of PAE-az, PAE-al and pure PAE looked similar as shown in FIG. 19, however, the characteristic peak of C═N group from PAE-az could still be found in the spectrum at around 2100 cm⁻¹ and there were extra peaks at 2700-3000 cm⁻¹ which could be contributed from the alkyne CH group. Moreover, the colour difference between the pure PAE, PAE-al and PAE-az could indicate the successful introduction of alkyne and azide group to the PAE-al and PAE-az as well (FIG. 20). As mentioned in the formation and fabrication section, pure PAE had milky colour while PAE-al had light milky colour. For PAE-az, since 4-vinylbenzyl azide was dark yellow in colour, the introduction of azide to PAE resulting the formation of PAE-az with yellowish milky colour.

The clicked top layer solution was first sprayed on the primer coated PP-EPDM substrate (FIG. 18) to determine the clicked dual layer coating performance which includes thickness, hardness, and adhesion as well as water and ethanol resistance properties. The dual layer coating thickness was around 40-50 μm and the hardness was 4B by pencil hardness measurement. While ASTM class 5B by cross-hatch cutter test could be achieved for the adhesion of the dual coating on PP-EPDM substrate. Besides, the clicked dual coating can withstand rubbing with water and ethanol.

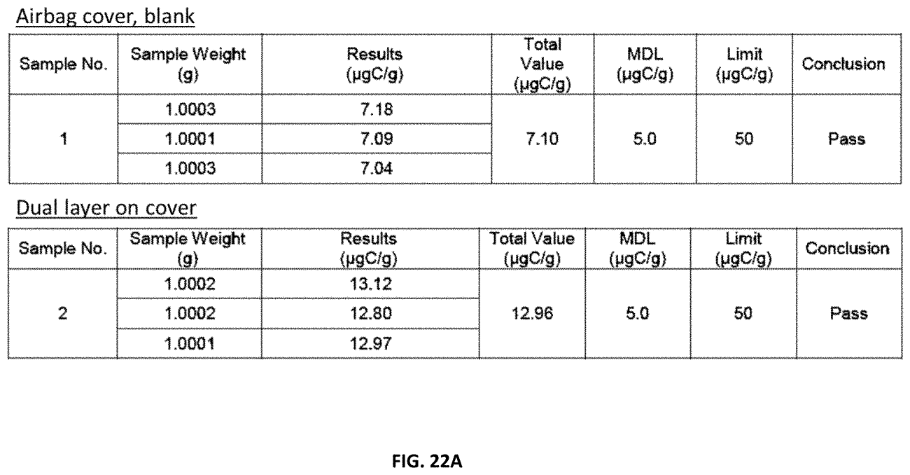

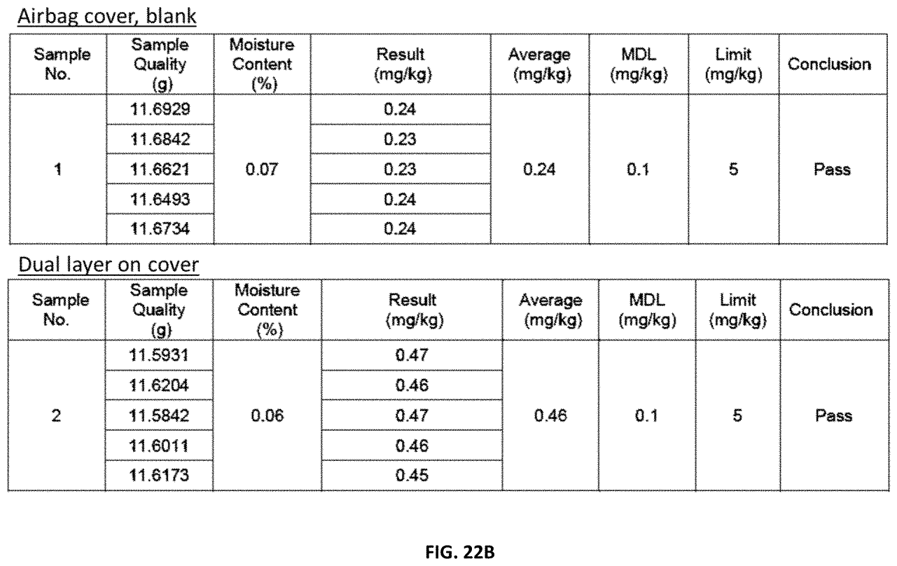

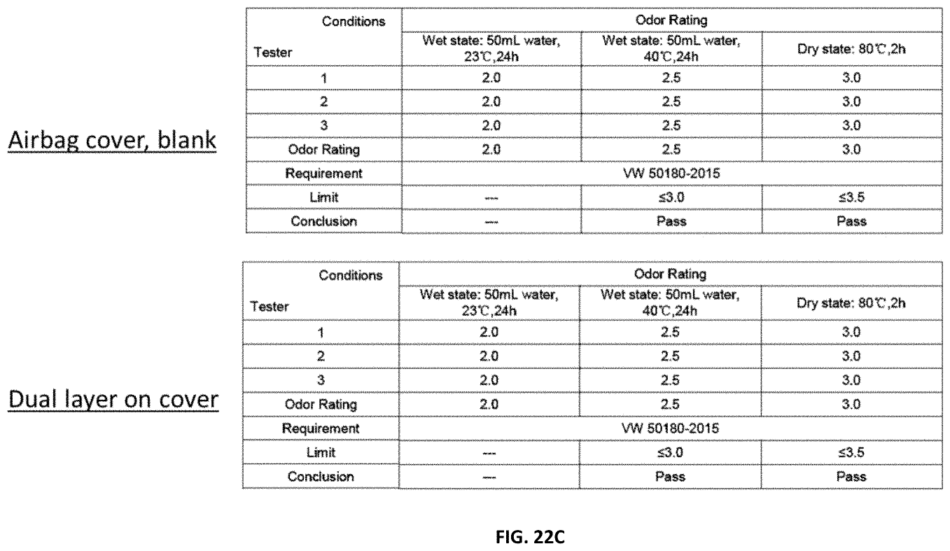

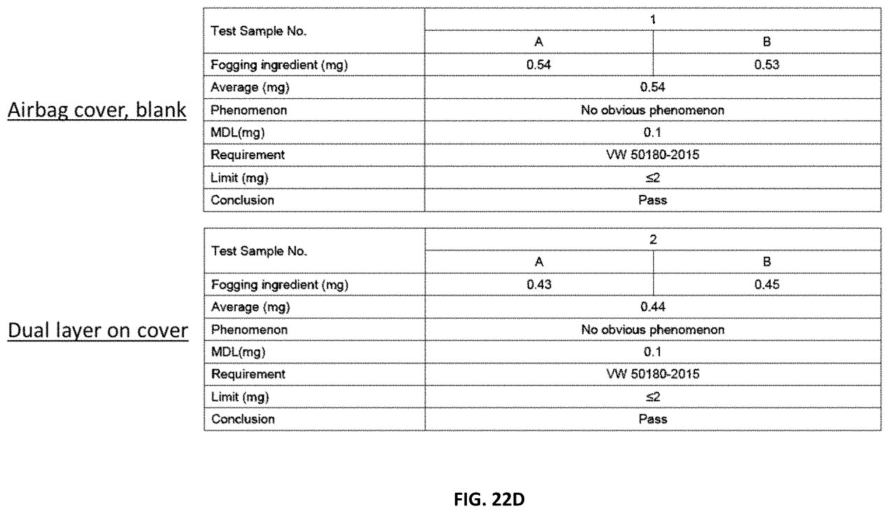

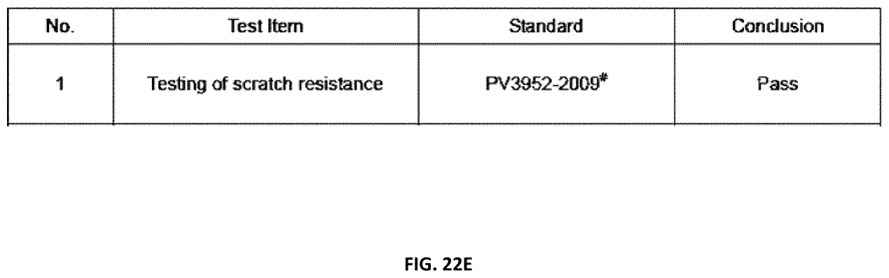

Coating samples were sent to third-party testing laboratory for the VOC emission and scratch resistance tests based on the test standard VW 50180. Total of four test items of the VOC emission were carried out: total volatile organic compound (TVOC) test to determine the total amount of volatile organic compound emitted from the coating, emission of formaldehyde test to determine the total amount of HCOH emitted from the coating, odour test to determine the odour resulting from the climatic exposure from the coating and fogging test to determine the fogging condensate value of the coating. All the results were summarised in Table 7 and the test reports were displayed in FIG. 22. All the VOC test results of the dual coating were able to comply with the test standard VW 50180. Besides, the scratch resistance was also complied with the testing criteria by the scratch resistance was also complying with the testing criteria by scratch hardness tester with 1 mm diameter test tip and under the contact force of 10N and scratching speed of 1,000 mm/min, and no penetration to substrate was observed after testing.

Additional testing results of the coating composition are shown in FIGS. 22A to 22E.

What is claimed is:

1. A coating composition comprising a first layer and a second layer disposed on top of the first layer, wherein the first layer comprises colloidal silica and a first polymer comprising monomer units represented by the structures: 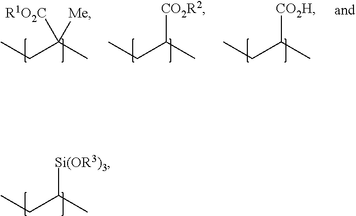
wherein R¹ is alkyl, R² is alkyl, and each R³ is independently hydrogen or an oxygen-silicon covalent bond to at least a portion of the colloidal silica; and
the second layer comprises a carbon additive and a crosslinked polymer comprising a second polymer and a third polymer, wherein the second polymer comprises monomer units represented by the structures: 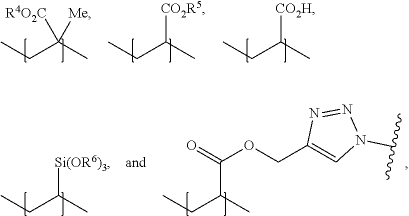
wherein R⁴ is alkyl, R⁵ is alkyl, and each R⁶ is alkyl; and the third polymer comprises monomer units represented by the structures: 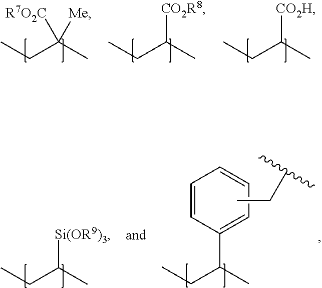
wherein R⁷ is alkyl, R⁸ is alkyl, and each R⁹ is alkyl, wherein 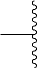
in the second polymer and 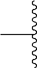
in the third polymer represents a covalent bond therebetween.

2. The coating composition of claim 1, wherein the carbon additive is selected from the group consisting of graphene, graphite, carbon black, carbon nanotubes, and combinations thereof.

3. The coating composition of claim 1, wherein R¹, R⁴, and R⁷ are independently C₁-C₃ alkyl; R², R⁵, and R⁸ are independently C₂-C₆ alkyl; and R⁶ and R⁹ is C₁-C₂ alkyl.

4. The coating composition of claim 1, wherein the first polymer comprises the monomer units: 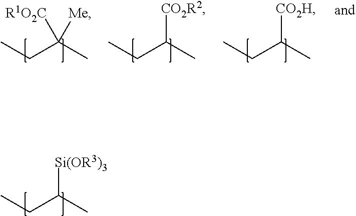
in approximately a 10:10:10:1 molar ratio, respectively.

5. The coating composition of claim 4, wherein the second polymer comprises the monomer units: 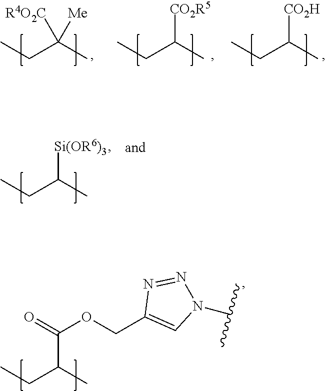
in approximately a 10:10:10:1:1 molar ratio, respectively; and the third polymer comprises the monomer units: 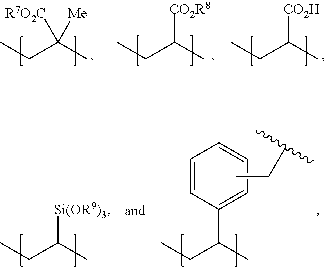
in approximately a 10:10:10:1:1 molar ratio, respectively.

6. The coating composition of claim 5, wherein the carbon additive is graphene.

7. The coating composition of claim 1, wherein first layer comprises colloidal silica and third polymer in a 4:1 ratio by weight; the first polymer comprises the monomer units: 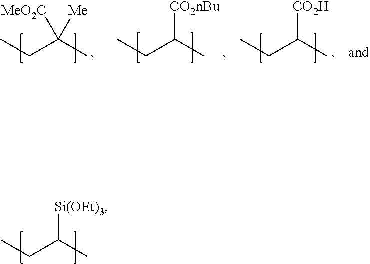
in a 10:10:10:1 molar ratio, respectively; the second polymer comprises the monomer units: 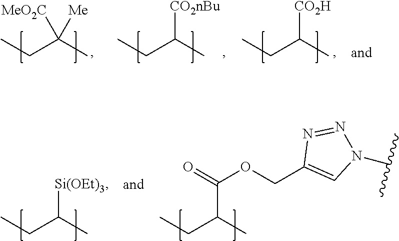
in a 10:10:10:1:1 molar ratio, respectively; the third polymer comprises the monomer units: 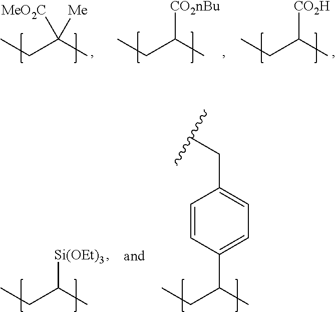
in a 10:10:10:1:1 molar ratio, respectively; and the carbon additive is graphene.

8. A method for applying the coating composition of claim 1 to a substrate, the method comprising: contacting the surface of the substrate with a first composition comprising colloidal silica and a first polymer comprising monomer units represented by the structures: 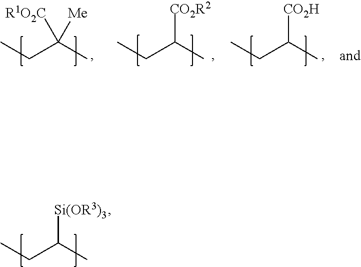
wherein R¹ is alkyl, R² is alkyl, and each R³ is independently hydrogen or an oxygen-silicon covalent bond to at least a portion of the colloidal silica thereby forming a first layer disposed on top of the substrate; contacting the surface of the first layer with a second composition comprising a carbon additive, a second polymer precursor, and a third polymer precursor, wherein the second polymer precursor comprises monomer units represented by the structures: 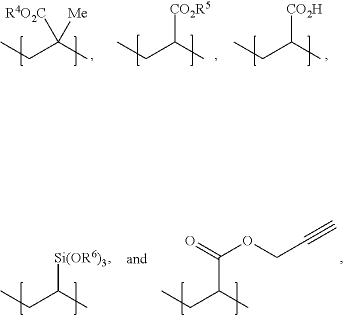
wherein R⁴ is alkyl, R⁵ is alkyl, and each R⁶ is alkyl; and the third polymer precursor comprises monomer units represented by the structures: 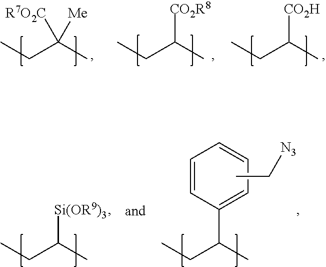
wherein R⁷ is alkyl, R⁸ is alkyl, and each R⁹ is alkyl thereby forming a thin film disposed on top of the first layer; and subjecting the thin film to a condition for facilitating a [3+2] cycloaddition reaction of the second polymer precursor and the third polymer precursor thereby forming the second layer comprising the crosslinked polymer.

9. The method of claim 8, wherein the carbon additive is selected from the group consisting of graphene, graphite, carbon black, carbon nanotubes, and combinations thereof.

10. The method of claim 8, wherein the substrate is an airbag cover.

11. The method of claim 10, wherein the airbag cover comprises polypropylene/ethylene-propylene-diene-monomer (PP-EPDM).

12. The method of claim 8, wherein R¹, R⁴, and R⁷ are independently C₁-C₃ alkyl; R², R⁵, and R⁸ are independently C₂-C₆ alkyl; and R⁶ and R⁹ is C₁-C₂ alkyl.

13. The method of claim 8 further comprising the step of contacting the second composition with a copper salt.

14. The method of claim 8, wherein the condition for facilitating the [3+2] cycloaddition reaction comprises subjecting the thin film to heat.

15. The method of claim 8 further comprising the step of polymerizing: 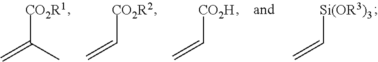
thereby forming a first polymer precursor comprising monomer units represented by the structures: 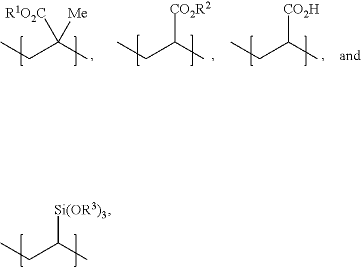
wherein R¹ is alkyl, R² is alkyl, and R³ is alkyl; contacting the first polymer precursor with colloidal silica thereby forming the first polymer.

16. The method of claim 15, wherein 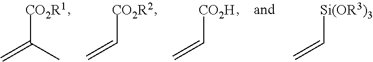
are present in a molar ratio of approximately a 10:10:10:1 to molar ratio, respectively.

17. The method of claim 8 further comprising the step of polymerizing: 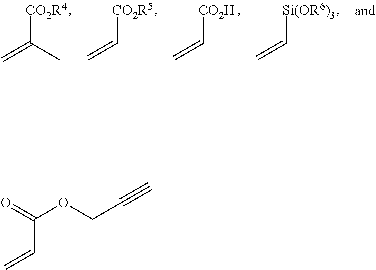
thereby forming the second polymer precursor.

18. The method of claim 8 further comprising the step of polymerizing 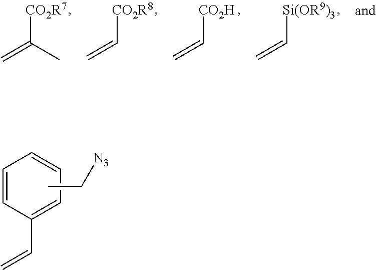
thereby forming the third polymer precursor.

19. A kit for preparing the coating composition of claim 1, the kit comprising:
a first container comprising colloidal silica and a first polymer comprising monomer units represented by the structures: 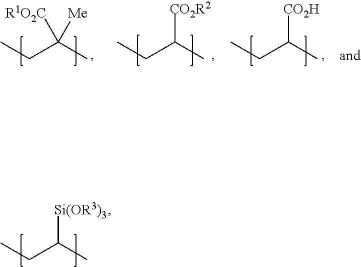
wherein R¹ is alkyl, R² is alkyl, and each R³ is independently hydrogen or an oxygen-silicon covalent bond to at least a portion of the colloidal silica; a second contacting comprising a second polymer precursor comprising monomer units represented by the structures: [chemical structure]
